(19) United States
(12) Patent Application Publication
(10) Pub. No.: US 2020/0040131 A1
(43) Pub. Date: Feb. 6, 2020

(54) PHOTOCURABLE RESIN COMPOSITION, ADHESIVE, STACKED STRUCTURE, METHOD FOR FABRICATING THE STACKED STRUCTURE, AND DISPLAY DEVICE

(71) Applicant: PANASONIC INTELLECTUAL PROPERTY MANAGEMENT CO., LTD., Osaka (JP)

(72) Inventors: Yusuke FUKAMOTO, Mie (JP); Shinsuke YOSHIDA, Osaka (JP); Yozo MATSUKAWA, Nara (JP); Morio NAKATANI, Aichi (JP); Koso MATSUNO, Osaka (JP)

(73) Assignee: PANASONIC INTELLECTUAL PROPERTY MANAGEMENT CO., LTD., Osaka (JP)

(21) Appl. No.: 16/496,085

(22) PCT Filed: Mar. 22, 2018
(86) PCT No.: PCT/JP2018/011462

§ 371 Date: Sep. 20, 2019

(30) Foreign Application Priority Data
Mar. 22, 2017 (JP) 2017-056378
Oct. 26, 2017 (JP) 2017-207550
Oct. 26, 2017 (JP) 2017-207551

(51) Int. Cl. C08G 59/22; C08L 33/04; C08L 63/00; C09J 11/06; C09J 163/00; C09J 4/06; C09J 5/00; C09J 7/30; G02F 1/1333; G09F 9/00

(52) U.S. Cl. CPC C08G 59/22; C08L 33/04; C08L 63/00; C09J 11/06; G09F 9/00; C09J 4/06; C09J 5/00; C09J 7/30; G02F 1/1333; C09J 163/00

(57) ABSTRACT

An adhesive contains: (A) a monofunctional epoxy compound having one epoxy group per molecule; (B) a polyfunctional epoxy compound having two or more epoxy groups per molecule; (C) a photo cation generator; (D) an acrylic compound; (E) a photo-radical generator; and at least one compound selected from the group consisting of (F) a monofunctional oxetane compound and (H) a polyfunctional oxetane compound.

### TECHNICAL FIELD

The present invention generally relates to a photocurable resin composition, an adhesive, a stacked structure, a method for fabricating the stacked structure, and a display device. More particularly, the present invention relates to a photocurable resin composition to cure when exposed to an active energy ray such as an ultraviolet ray, an adhesive containing such a photocurable resin composition, a stacked structure including the adhesive, a method for fabricating such a stacked structure, and a display device including the adhesive.

### BACKGROUND ART

An electronic device such as a liquid crystal panel is a stacked structure fabricated by stacking a plurality of members one on top of another and bonding them together with an adhesive. Various types of adhesives may be used to fabricate the stacked structure.

Examples of the adhesives include an optically clear adhesive (OCA) in the form of a film and an optically clear resin (OCR), to name just a few.

For example, Patent Literature 1 teaches bonding a substrate and a sensor with an OCA during the manufacturing process of a touch-screen panel. According to Patent Literature 1, the substrate and the sensor are bonded together with tackiness of the OCA.

Meanwhile, Patent Literature 2 teaches bonding a transparent touch-sensitive switch and a liquid crystal display element together with a UV-curable clear adhesive during the manufacturing process of a display device. In this case, the clear adhesive is arranged between the transparent touch-sensitive switch and the liquid crystal display element and then allowed to cure through exposure to an ultraviolet ray.

### CITATION LIST

### Patent Literature

Patent Literature 1: JP 2014-21968 A

Patent Literature 2: JP H09-274536 A

However, using the OCA to bond a plurality of members as disclosed in Patent Literature 1 may allow, when the OCA 51 in the form of a film is applied to a step 50, air bubbles 52 to enter a gap between the step 50 and the OCA 51 due to failure to force the air out as shown in FIG. 11.

On the other hand, using the UV-curable OCR to bond a plurality of members together as disclosed in Patent Literature 2 may leave the adhesive 55 partially uncured to cause insufficient bonding or resin leakage. This is because, as shown in FIGS. 12A and 12B, when a member 53 having a portion 56 with low optical transmittance and a member 54 are bonded together with the OCR adhesive 55, incoming light 57 could be cut off by the portion 56 to possibly leave the part of the adhesive 55 under the portion 56 uncured. The resin leakage caused after the members 53 and 54 have been attached together or after the assembly could make the backlight, housing, circuit board, or any other component contaminated with the resin. In addition, the presence of an uncured adhesive 60 could allow the adhesive 60 to overflow as shown in FIGS. 13A and 13B when members 58 and 59 are attached to each other. Such overflow of the adhesive from an originally designed adhesive region could cause a lack of a sufficiently broad adhesive area to bond the housing tightly enough. A product with such air bubbles, resin leakage, or adhesive overflow tends to be discarded as a defective product. In addition, the need to expose the assembly to an ultraviolet ray after the members have been attached to each other prevents a UV-curable adhesive from being used to bond a member with low optical transmittance.

### SUMMARY OF INVENTION

It is therefore an object of the present invention to provide an adhesive with the ability to reduce the chances of air bubbles entering itself and the chances of being left uncured and with the applicability to bond even members with low optical transmittance, and also provide a stacked structure including such an adhesive and a method for fabricating a stacked structure using such an adhesive.

An adhesive according to an embodiment of the present invention contains: a monofunctional epoxy compound having one epoxy group per molecule as Component (A); a polyfunctional epoxy compound having two or more epoxy groups per molecule as Component (B); a photo cation generator as Component (C); an acrylic compound as Component (D); a photo-radical generator as Component (E); and at least one compound selected from the group consisting of a monofunctional oxetane compound as Component (F) and a polyfunctional oxetane compound as Component (H).

A stacked structure according to another embodiment of the present invention includes: a cured product of the adhesive; a first member; and a second member. The first member and the second member are fixed together with the cured product.

A method for fabricating a stacked structure according to another embodiment of the present invention includes: an arrangement step of arranging an uncured coating of the adhesive on at least one member selected from the group consisting of a first member and a second member; an irradiation step of irradiating the uncured coating with an active energy ray after the arrangement step has been performed; a positioning step of positioning the first member and the second member with the uncured coating interposed after the irradiation step has been performed; and a curing step of fixing the first member and the second member together by completely curing the uncured coating after the positioning step has been performed.

The present invention provides an adhesive with the ability to reduce the chances of air bubbles entering itself and the chances of being left uncured and with the applicability to bond even members with low optical transmittance, and also provides a stacked structure including such an adhesive and a method for fabricating a stacked structure using such an adhesive.

### BRIEF DESCRIPTION OF DRAWINGS

FIG. 1A is a graph showing the storage modulus and loss modulus measured right after an exemplary adhesive according to an embodiment of the present invention has been irradiated with an active energy ray;

FIG. 1B is a graph showing the storage modulus measured right after the exemplary adhesive has been irradiated with an active energy ray;

FIG. 2A is a schematic front view illustrating the process step of arranging a coating of the adhesive on a member;

FIG. 2B is a schematic cross-sectional view illustrating the process step of arranging the coating of the adhesive on the member;

FIG. 3 is a schematic cross-sectional view illustrating the process step of irradiating a coating of the adhesive with an active energy ray;

FIG. 4A is a schematic front view illustrating the process step of removing a frame from the coating of the adhesive;

FIG. 4B is a schematic cross-sectional view illustrating the process step of removing the frame from the coating of the adhesive;

FIG. 5 is a schematic cross-sectional view illustrating the process step of attaching a plurality of members to each other with the coating of the adhesive;

FIG. 6 is a schematic cross-sectional view illustrating an exemplary stacked structure according to an embodiment of the present invention;

FIG. 7A is a schematic perspective view illustrating the process step of arranging, on a member, a coating of an adhesive according to an embodiment of the present invention;

FIG. 7B is an enlarged view of a portion indicated by the dotted circle in FIG. 7A;

FIG. 8 is a schematic perspective view illustrating the process step of irradiating the coating of the adhesive with an active energy ray;

FIG. 9 is a schematic perspective view illustrating the process step of attaching a plurality of members to each other with the coating of the adhesive;

FIG. 10 is a schematic cross-sectional view illustrating an exemplary stacked structure according to an embodiment of the present invention;

FIG. 11 is a schematic cross-sectional view illustrating a situation where an OCA is arranged on a member with a level difference;

FIG. 12A is a schematic representation illustrating a situation where a member including a portion with a low optical transmittance is bonded with an OCR;

FIG. 12B is an enlarged view of a portion indicated by the dotted circle in FIG. 12A;

FIG. 13A is a schematic front view illustrating a situation where a plurality of members are attached to each other with an OCR;

FIG. 13B is an enlarged view of a portion indicated by the dotted circle in FIG. 13A;

FIG. 14 is a cross-sectional view illustrating an embodiment of a stacked structure according to the present invention;

FIGS. 15A-15G are schematic representations illustrating an embodiment of a method for fabricating a stacked structure according to the present invention;

FIG. 16 is a schematic representation illustrating an exemplary system for fabricating a stacked structure;

FIGS. 17A-17F are schematic representations illustrating a typical known method for fabricating a stacked structure;

FIG. 18 is a cross-sectional view illustrating an embodiment of a display device according to the present invention;

FIGS. 19A-19G are schematic representations illustrating an exemplary process step of bonding a cover and a liquid crystal panel together for a display device according to the present invention; and

FIG. 20 is a schematic representation illustrating an exemplary known display device.

### DESCRIPTION OF EMBODIMENTS

Embodiments of the present invention will now be described.

1. Photocurable Resin Composition

A photocurable resin composition according to an exemplary embodiment (hereinafter also referred to as Composition (X)) is a photocurable resin composition to be cured by being irradiated with light. As used herein, the “light” refers to an active energy ray, examples of which include an ultraviolet ray and may include visible radiation.

As used herein, the curing reaction that proceeds while the Composition (X) is being irradiated with light will be hereinafter referred to as “primary curing.” The curing reaction that is initiated when a predetermined amount of time passes since the primary curing and that proceeds steeply will be hereinafter referred to as “secondary curing.” The state of the Composition (X) from a point in time when the storage modulus thereof exceeds the loss modulus thereof due to the primary curing through a point in time when the secondary curing is initiated will be hereinafter referred to as “primarily cured.” The state of the Composition (X), of which the adhesive strength has increased to 1 N/cm² or more as a result of the secondary curing, will be hereinafter referred to as “secondarily cured.” The full curing of the Composition (X) that has gone through the secondary curing will be hereinafter referred to as “complete curing.” The amount of time it takes for the Composition (X) to be completely cured since the initiation of the secondary curing will be hereinafter referred to as a “curing completion period.” The state of the Composition (X), of which the storage modulus has been saturated, will be hereinafter referred to as “completely cured.”

The Composition (X) contains: (A) a monofunctional epoxy compound (hereinafter referred to as “Component (A)”); (B) a polyfunctional epoxy compound (hereinafter referred to as “Component (B)”); (C) a photo cation generator (hereinafter referred to as “Component (C)”); (D) an acrylic compound (hereinafter referred to as “Component (D)”); (E) a photo-radical generator (hereinafter referred to as “Component (E)”); (F) a monofunctional oxetane compound (hereinafter referred to as “Component (F)”); (G) an elastomer (hereinafter referred to as “Component (G)”); (H) a polyfunctional oxetane compound (hereinafter referred to as “Component (H)”); and (I) a coupling agent (hereinafter referred to as “Component (I)”).

In one embodiment, the Composition (X) includes the Components (A), (B), (C), (D), (E), and (F) as essential components and may include any of the other components as optional ingredients.

In another embodiment, the Composition (X) includes the Components (B) and (F) as essential components, and may include any of the other components as optional ingredients.

In still another embodiment, the Composition (X) includes the Components (B), (C), and (I) and at least one of the Component (A) or (F) as essential components, and may include any of the other components as optional ingredients.

These Components (A), (B), (C), (D), (E), (F), (G), (H), and (I) will be described one by one.

1-1. Component (A)

The Component (A) is a compound having one epoxy group per molecule. In other words, the Component (A) is a compound having a functional epoxy group per molecule. The Component (A) causes the Composition (X) to exhibit slow curing properties. As used herein, the “slow curing properties” refer to properties that make the amount of time it takes for the Composition (X) to be completely cured since the Composition (X) has been irradiated with light longer than the duration of being irradiated with the light. In the Composition (X), the polymerization of the Composition (A) proceeds preferentially than the polymerization of the Components (B) and (H), and the gelation is delayed due to crosslinking between the Components (B) and (H). This imparts slow curing properties to the Composition (X).

The Component (A) suitably includes (A1) a monofunctional epoxy compound with a polyether skeleton per molecule (hereinafter referred to as “Component (A1)”). Naturally, the Component (A) may include (A2) a monofunctional epoxy compound with no polyether skeletons per molecule (hereinafter referred to as “Component (A2)”). The polyether skeleton is expressed by the following Chemical Structure Formula (1):

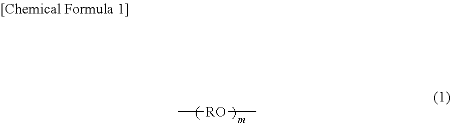

In Chemical Structure Formula (1), R is a hydrocarbon group with a carbon number of 1 to 30 and m is an integer of 2 to 60.

In Chemical Structure Formula (1), R is a hydrocarbon group with a carbon number of 1 to 10. This increases the amount of time it takes for the Composition (X) to be completely cured since the Composition (X) has been irradiated with light.

Examples of the compounds contained in the Component (A1) include polyethylene glycol monoglycidyl ether, polypropylene glycol monoglycidyl ether, and polytetramethylene glycol monoglycidyl ether. The Component (A) suitably includes at least one of these compounds.

Examples of the compounds contained in the Component (A2) include alkyl glycidyl ether, phenyl glycidyl ether, para tertiary butyl phenyl glycidyl ether, cresyl glycidyl ether, biphenyl glycidyl ether, glycol glycidyl ether, alkyl phenol glycidyl ether, cyclohexene oxide, and fatty acid glycidyl ester. The Component (A) may include at least one of these compounds.

The Component (A) is more suitably a compound having no or almost no carbon-carbon double bonds. The reason is that a compound having a carbon-carbon double bond tends to have its β bond cut off with heat and light, thus making the Composition (X) and a cured product thereof easily discolored (in particular, turned yellowish due to thermal oxidation degradation). As used herein, the compound having almost no carbon-carbon double bonds refers to a compound, of which the double bond in a structure has been treated by hydrogenation reaction to have a hydrogenation rate of 70% or more. Meanwhile, a compound with a hydrogenation rate less than 70% is not suitable because its carbon-carbon double bond tends to be cut off with heat and light to make the Composition (X) and a cured product thereof discolored (in particular, turned yellowish due to thermal oxidation degradation). Using such a compound having almost no carbon-carbon double bonds reduces the chances of the Composition (X) and a cured product thereof being discolored. A monofunctional epoxy compound having almost no carbon-carbon double bonds may be a monofunctional epoxy compound treated by hydrogenation reaction.

1-2. Component (B)

Component (B) is a compound having two or more epoxy groups per molecule. In other words, the Component (B) is a compound having an at least bifunctional epoxy group per molecule.

The Component (B) suitably includes (B1) a polyfunctional epoxy compound with a polyether skeleton per molecule (hereinafter referred to as “Component (B1)”). Naturally, the Component (B) may include (B2) a polyfunctional epoxy compound with no polyether skeletons per molecule (hereinafter referred to as “Component (B2)”). Particularly, the Components (A) and (B) both having a polyether skeleton reduce the chances of the polyether skeleton being bred out (i.e., oozing out or surfacing of the polyether skeleton onto the surface of the cured product of the Composition (X)) after the Composition (X) has been cured.

Examples of the compounds contained in the Component (B1) include polyethylene glycol diglycidyl ether, polypropylene glycol diglycidyl ether, and polytetramethylene glycol diglycidyl ether. The Component (B) suitably includes at least one of these compounds.

Examples of the compounds contained in the Component (B2) include bisphenol A type epoxy resins, bisphenol F type epoxy resins, bisphenol S type epoxy resins, biphenyl type epoxy resins having a biphenyl skeleton, naphthalene ring-containing epoxy resins, anthracene ring-containing epoxy resins, alicyclic epoxy resins, dicyclopentadiene type epoxy resins having a dicyclopentadiene skeleton, phenol novolak type epoxy resins, cresol novolak type epoxy resins, triphenylmethane type epoxy resins, brominated epoxy resins, aliphatic epoxy resins, aliphatic polyether-based epoxy resins, and triglycidyl isocyanurates. The Component (B) may include one or more of these compounds.

The Component (B) suitably contains (B3) a polyfunctional epoxy compound treated by hydrogenation reaction (hereinafter referred to as “Component (B3)”). The reason is that a polyfunctional epoxy compound having a double bond tends to have its B bond cut off with heat and light, thus making the Composition (X) and a cured product thereof easily discolored (in particular, turned yellowish due to thermal oxidation degradation). As used herein, the hydrogenation reaction refers to a reduction reaction for adding hydrogen to a double bond that is originally included in the structure of a compound, and allows the number of double bonds in the compound to be reduced with the structure of the compound yet to be subjected to the hydrogenation maintained. Therefore, a compound treated by the hydrogenation reaction has its β bond cut off with heat and light less easily than a compound not treated by the hydrogenation. That is why the Composition (X) suitably contains, as the Component (B), the Component (B3) having almost no double bonds and treated by the hydrogenation reaction, thus reducing the discoloration of the Composition (X) and a cured product thereof. As used herein, the compound having almost no carbon-carbon double bonds refers to a compound, of which the double bond in a structure has been treated by the hydrogenation reaction to have a hydrogenation rate of 70% or more. Meanwhile, a compound with a hydrogenation rate less than 70% is not suitable because its carbon-carbon double bond tends to be cut off with heat and light to make the Composition (X) and a cured product thereof discolored (in particular, turned yellowish due to thermal oxidation degradation). Examples of the Component (B3) include polyfunctional epoxy compounds treated by the hydrogenation reaction such as hydrogenated bisphenol A type epoxy resins, hydrogenated bisphenol F type epoxy resins, and hydrogenated polybutadiene type epoxy resins. Using such a hydrogenated raw material reduces the number of double bonds while maintaining the physical properties of the composition yet to be subjected to the hydrogenation, thus reducing the chances of the double bonds being cut off and also reducing the chances of the composition being degraded due to thermal oxidation or turning yellowish.

1-3. Component (C)

Component (C) is a compound that generates a cationic species as a strongly acidic chemical species by being irradiated with light such as an ultraviolet ray or visible radiation. This chemical species allows an epoxy group or an oxetane ring to produce ring-opening self-polymerization. Thus, the Component (C) is an initiator to cause an epoxy group or an oxetane ring to produce ring-opening self-polymerization. The Component (C) may include either an ionic photoacid generator or a nonionic photoacid generator, or both.

Examples of compounds contained in the ionic photoacid generator include onium salts such as aromatic diazonium salts, aromatic halonium salts, and aromatic sulfonium salts, and organic metal complexes such as an iron-allene complex, a titanocene complex, iodonium salts, and an aryl silanol-aluminum complex. Component (C) may contain one or more of these compounds. The Component (C) may include a commercially available ionic acid generator. Examples of commercially available ionic acid generators include “Adeka Optomer” series such as Adeka Optomer SP150 and Adeka Optomer SP170 (names of products manufactured by ADEKA Corporation), CPI-210S and CPI-310B (names of products manufactured by San-Apro Ltd.), UVE-1014 (name of a product manufactured by General Electronics Co., Ltd.), and CD-1012 (name of a product manufactured by Sartomer Co., Ltd.). The Component (C) may include one or more of these ionic photoacid generators. Among these ionic photoacid generators, CPI-310B is a so-called borate type photo cation generator. Using such a borate type photo cation generator in combination with Component (i) to be described later further reduces the corrosion of the object to be bonded with the adhesive.

Examples of the compounds contained in the non-ionic photoacid generators include nitrobenzyl ester, sulfonic acid derivatives, phosphoric acid ester, phenol sulfonic acid ester, diazonaphthoquinone, and N-hydroxyimide phosphonates. The Component (C) may include one or more of these compounds.

1-4. Component (D)

The Component (D) is one of a monomer, an oligomer, or a polymer as a raw material for an acrylic resin. In other words, the Component (D) is a compound having an at least monofunctional reactive acrylic group or methacrylic group per molecule. Examples of the compounds contained in the Component (D) include monofunctional acrylates, polyfunctional acrylates, monofunctional methacrylates, and polymers including a reactive acrylic or methacrylic group per molecule. It is generally known that acrylic resins and methacrylic resins, which are cured products thereof, generally have too high weather resistance to be discolored easily. Increasing the percentage of such a component that is not discolored easily contributes to preventing the Composition (X) from being discolored.

Examples of the compounds contained in the monofunctional acrylates or the monofunctional methacrylates include methyl acrylate, methyl methacrylate, ethyl acrylate, ethyl methacrylate, normal propyl acrylate, normal propyl methacrylate, isopropyl acrylate, isopropyl methacrylate, normal butyl acrylate, normal butyl methacrylate, isobutyl acrylate, isobutyl methacrylate, cyclohexyl acrylate, cyclohexyl methacrylate, lauryl acrylate, lauryl methacrylate, stearyl acrylate, stearyl methacrylate, methacryloxypropyl trimethoxysilane, and methylol acrylamide. Examples of the compounds included in the polyfunctional acrylates or polyfunctional methacrylates include 1,4-butanediol diacrylate, 1,6-hexanediol diacrylate, 1,9-nonanediol diacrylate, triethylene glycol diacrylate, tetraethylene glycol diacrylate, cyclohexane dimethanol diacrylate, ethoxylated bisphenol A diacrylate, tricyclodecane dimethanol diacrylate, trimethylolpropane triacrylate, pentaerythritol triacrylate, pentaerythritol tetraacrylate, dendrimer acrylate, 1,4-butane diol dimethacrylate, 1,6-hexanediol dimethacrylate, triethylene glycol dimethacrylate, ethoxylated bisphenol phenol A dimethacrylate, and trimethylolpropane trimethacrylate. Examples of the polymers having reactive acrylic groups or methacrylic groups per molecule include epoxy acrylate, urethane acrylate, polyester acrylate, acrylic modified silicone, epoxy methacrylate, urethane methacrylate, polyester methacrylate, and methacrylic modified silicone. The Component (D) may include one or more of these compounds.

1-5. Component (E)

The Component (E) is a compound that generates a radical by being irradiated with light such as ultraviolet ray or visible radiation. This radical is able to produce radical polymerization of an acrylic compound. In other words, the Component (E) is a photo-radical polymerization initiator. The Component (E) is not particularly limited and may include any known photo-radical polymerization initiator. It is known that a cured product formed with such a photo-radical generator generally has a low degree of corrosivity. Increasing the percentage of such a component allows a cured product with a low degree of corrosivity to be obtained.

Examples of the compounds contained in the Component (E) include acetophenone-based, benzoin-based, benzophenone-based, thioxane-based, alkyl phenone-based, and acylphosphine oxide-based photo-radical polymerization initiators. The Component (E) may include one or more of these compounds.

1-6. Component (F)

The Component (F) is a compound having an oxetane ring per molecule. The Component (F) causes the Composition (X) to exhibit slow curing properties. As used herein, the “slow curing properties” refer to properties that increase the amount of time it takes for the Composition (X) to be completely cured since the Composition (X) has been irradiated with light. In the Composition (X), the polymerization of the Composition (F) proceeds preferentially than the polymerization of the Components (B) and (H), and the gelation is delayed due to crosslinking between the Components (B) and (H). This imparts slow curing properties to the Composition (X).

Examples of the compounds contained in the Component (F) include 3-ethyl-3-hydroxymethyl oxetane, 2-ethylhexyl oxetane, 3-ethyl-3-(2-ethylhexyloxymethyl) oxetane, 3-ethyl-3-(cyclohexyloxy)methyl oxetane, and 3-ethyl-3-(phenoxymethyl) oxetane. The Component (F) may include one or more of these compounds.

1-7. Component (G)

The Component (G) is an elastomer. The Composition (X) with an elastomer may have higher viscosity than the Composition (X) with no elastomers. A cured product of the Composition (X) with an elastomer may have its strength, modulus of elasticity, and degree of elongation controlled more easily than a cured product of the Composition (X) with no elastomers. This allows the viscosity of the Composition (X) to be adjusted to a suitable range for an application process. In addition, this also allows the modulus of elasticity and degree of elongation of the Composition (X) to be adjusted to suitable ranges for a member to be attached to each other with the adhesive.

Examples of the compounds contained in the elastomer include polyolefin-based, polystyrene-based, polyester-based, polyurethane-based, silicone-based, and acrylic polymer high-molecular substances. The Component (G) may include one or more of these high-molecular substances. When the Composition (X) contains an elastomer, the elastomer may be present in the form of particles or in the form of solution. Alternatively, an elastomer in the form of particles and an elastomer in the form of a solution may coexist.

The Component (G) more suitably contains (G2) an elastomer treated by hydrogenation reaction (hereinafter referred to as “Component (G2)”). The reason is that an elastomer having a double bond tends to have its β bond cut off with heat and light, thus making the Composition (X) and a cured product thereof easily discolored (in particular, turned yellowish). That is why the Composition (X) suitably contains, as the Component (G), the Component (G2) having almost no double bonds and treated by the hydrogenation reaction, thus reducing the discoloration of the Composition (X) and a cured product thereof. As used herein, the compound having almost no carbon-carbon double bonds refers to a compound, of which the double bond in a structure has been treated by the hydrogenation reaction to have a hydrogenation rate of 70% or more. Meanwhile, a compound with a hydrogenation rate less than 70% is not suitable because its carbon-carbon double bond tends to be cut off with heat and light to make the Composition (X) and a cured product thereof discolored (in particular, turned yellowish due to thermal oxidation degradation). Examples of the Component (G2) include elastomers treated by hydrogenation reaction such as hydrogenated polystyrene-based elastomers and hydrogenated polybutadiene-based elastomers. Using such a hydrogenated raw material reduces the number of double bonds while maintaining the physical properties of the composition yet to be subjected to the hydrogenation, thus reducing the chances of the double bonds being easily cut off and also reducing the chances of the composition being degraded due to thermal oxidation or turning yellowish.

1-8. Component (H)

The Component (H) is a compound having two or more oxetane rings per molecule. The Component (H) increases the steepness of curing the Composition (X). As used herein, the “steepness of curing” refers to a property of the Composition (X) that causes the Composition (X) to be completely cured in a shorter amount of time by making the curing rate of the Composition (X) (represented by an increase in viscosity per unit time) rise steeply in a short time.

Examples of the compounds contained in the Component (H) include xylylene bisoxetane, 3-ethyl-3 {[(3-ethyloxetane-3-yl)methoxy]methyl} oxetane, and oxetanyl silicate. The Component (H) may include one or more of these compounds.

The Component (H) is more suitably a compound having no or almost no carbon-carbon double bonds. The reason is that a compound having a carbon-carbon double bond tends to have its β bond cut off with heat and light, thus making the Composition (X) and a cured product thereof easily discolored (in particular, turned yellowish due to thermal oxidation degradation). As used herein, the compound having almost no carbon-carbon double bonds refers to a compound, of which the double-bond in a structure has been treated by hydrogenation reaction to have a hydrogenation rate of 70% or more. Meanwhile, a compound with a hydrogenation rate less than 70% is not suitable because its carbon-carbon double bond tends to be cut off with heat and light to make the Composition (X) and a cured product thereof discolored (in particular, turned yellowish due to thermal oxidation degradation). Examples of the polyfunctional oxetane compounds having almost no carbon-carbon double bonds include a polyfunctional oxetane compound treated by the hydrogenation reaction. Using such a polyfunctional oxetane compound having no or almost no carbon-carbon double bonds allows the steepness of curing to be increased without turning the Composition (X) yellowish.

1-9. Component (I)

The Component (I) is a coupling agent. The Component (I) contains a silane coupling agent having an organic functional group, of which the number of carbon atoms in a linear carbon chain is equal to or less than two (hereinafter referred to as “Component (i)”). The Component (I) may consist entirely of Component (i). Alternatively, part of the Component (I) may be Component (i) and the balance of the Component (I) may be another coupling agent.

Examples of the Component (i) include ones expressed by the following structure formulae (i-1) and (i-2):

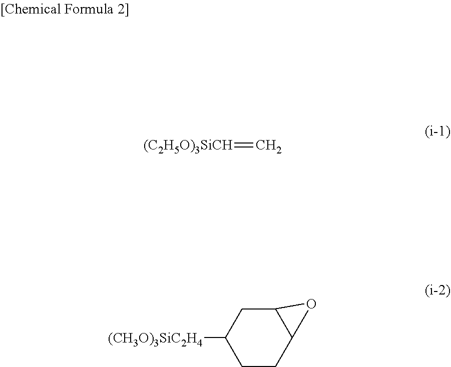

In the Composition (X) containing the Component (i), the Component (i) has an organic functional group with a small number of carbon atoms and has a short molecular chain. Thus, when the Composition (X) is brought into close contact with the surface of an object (such as an electrode) to be bonded with the adhesive, the Component (i) would stick to the surface of the object. Also, when the Component (i) forms a chemical bond with the Components (A) and (B), the Component (i) would be arranged densely on the surface of the object to be bonded with the adhesive. Thus, the Component (i) would be able to protect the surface of the object to be bonded, and would reduce the chances of a strong acid generated by the Component (C) affecting the object, and eventually reduce the chances of the object being corroded. On the other hand, in a coupling agent with a long organic functional group, the strong acid generated by the Component (C) tends to permeate the surface of the object through gaps with sparse chemical bonds. Thus, even though such a coupling agent may be effective to a certain degree, the coupling agent is not effective in reducing the corrosion of the object to be bonded.

1-10. Other Components

The Composition (X) may contain any of various types of resins and additives as needed.

1-11 Preparing Composition (X)

The Composition (X) may be obtained by compounding together the Components (A), (B), (C), (D), (E), (F), (G), (H) and (I) described above and other ingredients at a predetermined mass ratio, adjusting their temperature to a temperature falling within the range from 20° C. to 100° C., and then stirring the mixture up with a DISPER, for example, until the mixture has a uniform composition. This Composition (X) is substantially transparent and is more specifically pale yellow.

The Composition (X) may include the Components (A), (B), (C), (D), (E), (F), (G), (H) and (I) described above at the following ratios:

The content of the Component (A) suitably falls within the range from 0 parts by mass to 40 parts by mass, more suitably within the range from 1 part by mass to 30 parts by mass, relative to 100 parts by mass of the Composition (X).

The content of the Component (B) suitably falls within the range from 10 parts by mass to 95 parts by mass, more suitably within the range from 15 parts by mass to 70 parts by mass, relative to 100 parts by mass of the Composition (X).

The content of the Component (C) suitably falls within the range from 0.05 parts by mass to 5 parts by mass, more suitably within the range from 0.1 parts by mass to 3 parts by mass, relative to 100 parts by mass of the Composition (X).

The content of the Component (D) suitably falls within the range from 0 parts by mass to 70 parts by mass, more suitably within the range from 5 parts by mass to 30 parts by mass, relative to 100 parts by mass of the Composition (X).

The content of the Component (E) suitably falls within the range from 0 parts by mass to 5 parts by mass, more suitably within the range from 0.1 parts by mass to 3 parts by mass, relative to 100 parts by mass of the Composition (X).

The content of the Component (F) suitably falls within the range from 0 parts by mass to 90 parts by mass, more suitably within the range from 2 parts by mass to 30 parts by mass, relative to 100 parts by mass of the Composition (X). The content of the Component (F) is suitably equal to or greater than 5 parts by mass and may fall within the range from 5 parts by mass to 90 parts by mass.

The content of the Component (G) suitably falls within the range from 0 parts by mass to 80 parts by mass, more suitably within the range from 1 part by mass to 50 parts by mass, relative to 100 parts by mass of the Composition (X).

The content of the Component (H) suitably falls within the range from 1 part by mass to 30 parts by mass, more suitably within the range from 2 parts by mass to 15 parts by mass, relative to 100 parts by mass of the Composition (X).

The content of the Component (I) suitably falls within the range from 0.005 parts by mass to 5 parts by mass, more suitably within the range from 0.01 parts by mass to 3 parts by mass, and even more suitably within the range from 0.02 parts by mass to 1 part by mass, relative to 100 parts by mass of the Composition (X). The Component (I) with a content less than 0.005 parts by mass would achieve no practical effects. However, adding the Component (I) in excess of 5 parts by mass would significantly change the property of the resin. The content of the Component (I) is particularly suitably 1 part by mass or less, because the content is large enough to cover the surface of the electrodes on the surface of the substrate.

The ratio by mass of the total content of the Components (A) and (B) to the content of the Component (D) suitably falls within the range from 5:95 to 90:10. This allows, when a coating of the Composition (X) is irradiated with light, the coating to turn primarily cured so as to have tackiness but no adhesiveness while maintaining the shape of the coating. As used herein, the tackiness refers to the coating's capability of sticking to a base member by eliminating the space between the coating and the base member, being strippable with predetermined force, sticking again to the base member, and having as high adhesive strength as in the initial state. Meanwhile, the adhesiveness refers herein to the property of physically or chemically adhering tightly to the base member, but losing the tight adhesion and coming to have significantly decreased adhesive strength (specifically, decreasing to 50% or less) once the coating is stripped. The primary curing allows the coating to maintain its shape. Thus, this reduces the chances of the coating formed on a member from being deformed while the member is being transported. In addition, this also reduces the chances of the Composition (X) overflowing out of the adhesive member when a plurality of members are attached to each other with the coating. Furthermore, since the Composition (X) is applied in a liquid form onto the member, the coating may be formed to have a uniform thickness even if the surface of the member is curved. Besides, since the primary curing allows the coating to maintain its shape, a plurality of members with different curvatures may be attached to each other to have a uniform thickness.

The ratio by mass of the Component (A) to the Component (B) suitably falls within the range from 10:90 to 70:30, more suitably falls within the range from 15:85 to 60:40, and even more suitably falls within the range from 20:80 to 50:50.

The interval between primary curing and the start of secondary curing, i.e., the duration for which the Composition (X) remains primarily cured, varies according to the contents and types of the respective components. The duration becomes shorter as the contents of the Components (B) and (H) in the Composition (X) decrease, and becomes longer as the contents of the Components (A) and (F) in the Composition (X) increase. If the Composition (X) remains primarily cured for a long duration, a plurality of members (i.e., objects to be bonded together) can afford to be attached to each other with the Composition (X). The Composition (X), having the ability to maintain its shape and an appropriate degree of tackiness, will not flow out to another member or be displaced easily, and therefore, is very easy to handle during the manufacturing process. In addition, having the coating of the Composition (X) cured after having attached a plurality of members to each other allows the plurality of members to be bonded together without being affected by the optical transmittance of the members. Furthermore, eliminating the effect of the optical transmittance of the members allows the Composition (X) to be cured with light falling within a wavelength range that causes the Composition (X) to be cured more efficiently. Besides, this also allows the curing state and duration of the Composition (X) to be controlled uniformly. This eliminates the need to provide any light source for secondary curing, thus simplifying the manufacturing process. In addition, even if any members are changed during the manufacturing process, no adjustment or confirmation of the light source is needed any longer. Furthermore, the Composition (X) may also be applied to bonding opaque members, thus increasing the number of options of applicable members. On top of that, if any defect is spotted in the primarily cured product after the plurality of members have been attached to each other, the plurality of members may be once separated and then attached to each other again after the defect in the primarily cured product has been repaired. That is to say, this facilitates so-called “reworking.”

The ratio of the total content of the epoxy compounds, each having a polyether skeleton per molecule (i.e., the total content of (A1) the monofunctional epoxy compound and (B1) the polyfunctional epoxy compound), relative to 100 parts by mass of the total content of the Components (A) and (B) suitably falls within the range from 0.01 parts by mass to 90 parts by mass, and more suitably falls within the range from 0.1 parts by mass to 30 parts by mass.

The ratio of the content of the Component (C) relative to 100 parts by mass of the total content of the Components (A) and (B) is suitably equal to or greater than 0.01 parts by mass. This reduces the chances of the Composition (X) being uncured as a result of insufficient cationic polymerization reaction. In addition, the ratio of the content of the Component (C) relative to 100 parts by mass of the total content of the Components (A) and (B) is suitably equal to or less than 10 parts by mass. This reduces the chances of the cationic polymerization reaction rate becoming too high to ensure a sufficient pot life and also reduces the chances of the in-depth curing ability of the Composition (X) decreasing.

The ratio of the content of the Component (E) relative to 100 parts by mass of the total content of the Component (D) suitably falls within the range from 0.01 parts by mass to 10 parts by mass. If the content of the Component (E) were less than 0.01 parts by mass, the Component (D) would be uncured to possibly cause resin leakage due to insufficient curing. On the other hand, if the content of the Component (E) were more than 10 parts by mass, then the Composition (X) would be cured excessively and could become rather brittle.

The ratio of the content of the Component (F) relative to 100 parts by mass of the total content of the Components (A) and (B) suitably falls within the range from 0.1 parts by mass to 30 parts by mass. This allows the viscosity of the Composition (X) to rise even more steely during curing. Consequently, this shortens the curing time that is the amount of time it takes for the adhesive to be cured completely after a plurality of members have been attached to each other with the adhesive. In addition, this further reduces the chances of the plurality of members being displaced after having been attached to each other.

Furthermore, at least one component selected from the group consisting of the Component (A) and the Component (B) having a polyether skeleton allows the cationic polymerization reaction rate to be decreased even more effectively. This separates, on the time axis, the radical polymerization reaction occurring while the Composition (X) is being irradiated with light from the cationic polymerization reaction that starts to proceed when a predetermined amount of time passes since the irradiation with light.

Furthermore, if at least one component selected from the group consisting of the Component (A) and the Component (B) has a polyether skeleton and if the ratio of the content of the Component (H) relative to 100 parts by mass of the total content of the Components (A) and (B) falls within the range from 0.1 parts by mass to 30 parts by mass, the radical polymerization reaction occurring while the Composition (X) is being irradiated with light is separable on the time axis from the photo cationic reaction that starts to proceed when a predetermined amount of time passes since the irradiation with light. In addition, this also allows the cationic polymerization reaction to proceed more steeply after a predetermined amount of time has passed, thus completing the curing in a shorter time.

That is to say, the Components (A) and (B) not only allow the Composition (X) to be primarily cured through the radical polymerization reaction while the Composition (X) is being irradiated with light but also allow a plurality of members to be attached to each other during a predetermined period after the Composition (X) has been irradiated with light. This predetermined period ensures a sufficient time for bonding. After the members have been attached to each other, the Component (F) causes the cationic polymerization reaction to proceed steeply, thus making the Composition (X) cured completely. Completing the curing in a shorter time allows the products to be shipped in a shorter time. This allows the products in process to be kept particularly small in number during the in-factory process, thus cutting down the manufacturing cost.

If the Composition (X) contains an elastomer (Component (G)), then the ratio of the content of the Component (G) relative to 100 parts by mass of the total content of the Components (A) and (B) suitably falls within the range from 0.1 parts by mass to 90 parts by mass. This imparts various functions to the Composition (X) and a cured product of the Composition (X). For example, this allows the viscosity of the Composition (X) to be adjusted according to the intended use of the production facility of the factory. In addition, this also allows the modulus of elasticity of the cured product of the Composition (X) to be adjusted. Therefore, this enables control of the modulus of elasticity of the Composition (X), which is required when there is a significant difference in thermally expansion coefficient between the members to be attached to each other.

The ratio of the content of a compound having no double bonds and not treated by hydrogenation reaction in the Composition (X) relative to 100 parts by mass of the Composition (X) is suitably equal to or greater than 50 parts by mass (50% by mass). As described above, a compound with double bonds tends to have the Composition (X) and its cured product to be discolored easily, and often turns them yellowish due to thermal oxidation degradation. The larger the content of such a compound with no double bonds is, the less likely the Composition (X) and its cured product are discolored. That is why the ratio of the content of such a compound having no double bonds and not treated by hydrogenation reaction to 100 parts by mass of the Composition (X) is suitably equal to or greater than 50 parts by mass. Furthermore, the ratio of the content of a compound treated by hydrogenation reaction relative to 100 parts by mass of the Composition (X) is suitably equal to or greater than 20 parts by mass (20% by mass). This reduces the chances of the Composition (X) and its cured product being discolored with heat and light, for example.

2. Curing Property of Composition (X)

The Composition (X) is in liquid form before being irradiated with light and will turn, when the coating of the Composition (X) is applied onto a given member, into a shape conforming to that of the given member. This reduces the chances of air bubbles entering the gap between the member and the coating. In addition, the Composition (X) is easily maintained in the liquid form unless irradiated with light, and therefore, has preservation stability good enough to be preserved at ordinary temperature unlike a thermosetting resin that should be preserved in a cold place.

Furthermore, while being irradiated with light, the Composition (X) comes to have a storage modulus higher than a loss modulus to be cured primarily, and comes to have decreased flowability. This allows the Composition (X) to maintain the coating shape. This reduces the chances of the coating being deformed and allows the coating to keep the same shape and the same thickness while the member with the coating of the Composition (X) is being transported and also reduces the Composition (X) overflowing when a plurality of members are attached to each other with the coating. Besides, the primarily cured Composition (X), having tackiness, is able to keep the members to be attached to each other fixed at optimum positions and hardly displaceable. Moreover, the coating may be formed in any arbitrary shape. For example, the primarily cured coating may be formed in a sheet shape by irradiating, with light, the Composition (X) that has already been arranged in a frame. For instance, a coating formed in a linear shape may be used to bond a member with a complex shape. That is to say, when the coating is formed, the Composition (X) is liquid, and therefore, may be applied in any arbitrary shape according to the shape of the given member, and may also be cured and bonded while maintaining the arbitrary shape by being irradiated with light.

The phenomenon that the Composition (X) turns primarily cured originates from the acrylic compound and the photo-radical generator. The Composition (X) according to this embodiment turns primarily cured by the following mechanism. Specifically, when the Composition (X) absorbs light, a radical derived from the photo-radical generator is generated instantaneously. This radical and the acrylic compound react with each other to produce a radical polymerization reaction of the acrylic compound. This radical polymerization reaction proceeds rapidly. Also, the radical polymerization reaction proceeds only while the Composition (X) is irradiated with light. After the Composition (X) has been irradiated with light, the radical goes inactive to end the radical polymerization reaction. As a result, the Composition (X) comes to have rapidly increased viscosity to turn primarily cured and have decreased flowability. Also, if the content of the acrylic compound in the Composition (X) is too much, then the Composition (X) would be cured completely. Thus, the content of the acrylic compound in the Composition (X) is suitably small enough to prevent the Composition (X) from being cured completely through the radical polymerization reaction. Furthermore, right after the Composition (X) has been irradiated with light, the epoxy compound (to be described later) reacts with the Composition (X) to generate a cation originating from the photo cation generator. However, the cationic polymerization reaction does not proceed smoothly due to the presence of the monofunctional epoxy compound as the Component (A) and the polyfunctional epoxy compound as the Component (B).

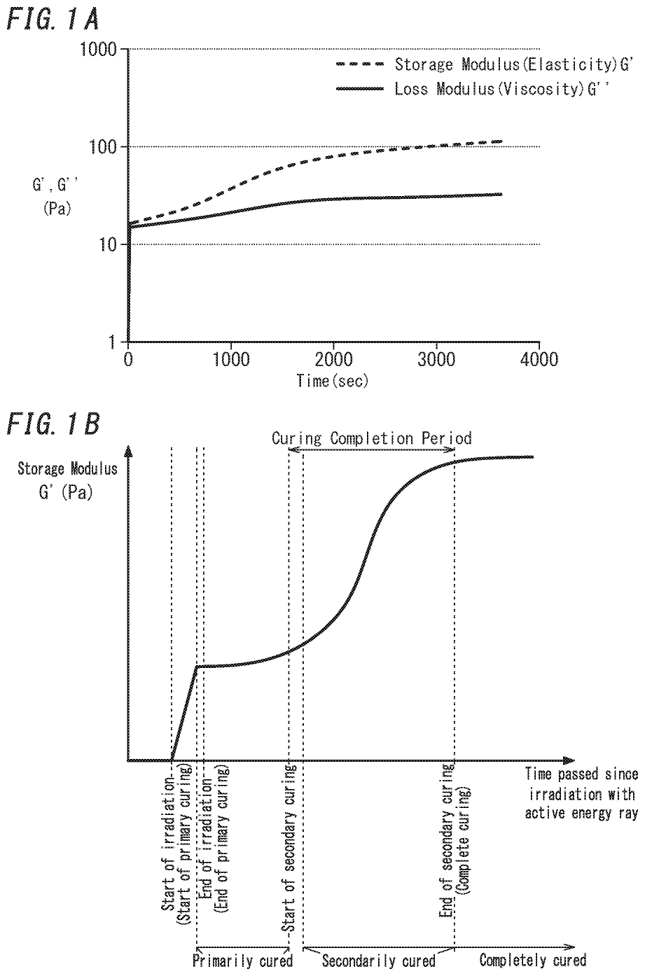

FIG. 1A shows the storage modulus G′ (Pa) and loss modulus G″ (Pa) of Composition (X) as an exemplary composition according to this embodiment, which were measured with a rheometer MCR-102 (manufactured by Anton Paar) right after the Composition (X) was irradiated with light. Note that the “storage” refers to a property of an elastic body and the “loss” refers to a property of a viscous body. According to these results of measurement, right after the Composition (X) has been irradiated with light, the storage modulus G′ (Pa) is greater the loss modulus G″ (Pa). That is to say, in the Composition (X) that has just been irradiated with light, the property of the elastic body outweighs the property of the viscous body. The Composition (X) in such a state tends to maintain its shape easily, thus reducing the chances of the coating of the Composition (X) being deformed and the chances of the Composition (X) overflowing while the members are being attached to each other.

For the predetermined period since the Composition (X) has been irradiated with light, the Composition (X) is kept primarily cured to be ready to maintain its shape, and exhibits tackiness but has no adhesiveness. Also, when cured completely, the Composition (X) is fixed. That is to say, the Composition (X) has slow curing properties. That is why the Composition (X) allows a sufficient amount of time to attach the plurality of members to each other after the Composition (X) has been irradiated with light, and therefore, allows a sufficient pot life long enough to attach those members to each other. Therefore, after the plurality of members have been attached to each other, the members are still separable and reworked easily. On the other hand, if the pot life was too long, then it would take a lot of time to perform the bonding process, thus resulting in lower productivity. That is to say, the present invention allows the curing property to be designed in an amount of time that is reasonably long for the production process, which is one of the advantages to be achieved by the present invention. Furthermore, even if no thermal or other energies are additionally applied to the Composition (X) after the plurality of members have been attached to each other, the curing reaction of the Composition (X) proceeds spontaneously, and is completed, just by being irradiated with light before the members are attached to each other. For example, even if opaque members or members with low optical transmittance are attached to each other, this also reduces the chances of the Composition (X) being left uncured. The slow curing properties of the Composition (X) originate from at least one of the monofunctional epoxy compound (Component (A)) or the monofunctional oxetane compound (Component (F)), the polyfunctional epoxy compound (Component (B)), and the photo cation generator (Component (C)).

FIG. 1B shows how the storage modulus G′ (Pa), measured with a rheometer MCR-102 (manufactured by Anton Paar), of Composition (X) as an exemplary composition according to this embodiment varies with time right after the Composition (X) was irradiated with light. According to the results shown in FIG. 1B, before the Composition (X) is irradiated with light, the storage modulus is low, and the Composition (X) is liquid. However, in the period from a point in time when the Composition (X) has just started to be irradiated with light through the end of the radiation with light, primary curing causes the storage modulus to rise steeply, thus turning the Composition (X) primarily cured and producing tackiness. Also, the storage modulus is kept constant for a certain period of time after the irradiation with light has ended. That is to say, the Composition (X) is kept primarily cured. Thereafter, secondary curing causes the storage modulus to start to rise steeply. The period during which the storage modulus rises steeply is a curing start period of secondary curing. Also, the Composition (X) that comes to have an adhesive strength equal to or greater than IN/cm² due to a steep increase in storage modulus is secondarily cured. That is to say, the secondary curing causes the Composition (X) to express adhesive strength. Thereafter, the storage modulus gets saturated and starts to rise gently, thus having the Composition (X) cured completely. The amount of time it takes for the Composition (X) to be cured completely since the start of secondary curing is a curing completion period.

The duration during which the Composition (X) is primarily cured varies according to the chemical makeup of the Composition (X), the irradiation intensity of light, the temperature of the Composition (X), and other parameters. That is to say, the amount of time it takes for the Composition (X) to start to cure secondarily since the Composition (X) has been irradiated with light is controllable. Supposing a plurality of members are actually attached to each other with the Composition (X), the Composition (X) suitably stays primarily cured for 5 seconds to 60 minutes right after the Composition (X) has been irradiated with light with a wavelength of 365 nm at a radiation dose of 50 mJ/cm² or more in an atmosphere at a temperature of 25° C., and then is suitably cured within 12 hours. The Composition (X) suitably has its chemical makeup adjusted to exhibit such a property.

If the Composition (X) stays primarily cured for less than S seconds, then there would not be a sufficient time to attach a plurality of members to each other, which is impractical. However, if the Composition (X) stays primarily cured for more than 60 minutes, the chances of the plurality of members being displaced would increase due to a variation in the temperature of the surrounding environment and artificial factors as well. In addition, it would take a longer time for the Composition (X) to be cured completely. Meanwhile, the curing completion period is suitably within 12 hours from the standpoint of productivity. The shorter the period is, the better. The radiation dose is suitably equal to or greater than 50 mJ/cm². If the radiation dose were less than this value, the quantity of cationic species to be generated by irradiation with light would be so small that the cationic polymerization reaction could stop or the Composition (X) could not be cured sufficiently. On the other hand, the larger the radiation dose is, the faster the cationic polymerization reaction will be, thus shortening the duration for which the Composition (X) stays primarily cured and the curing completion period. In the cationic polymerization reaction, the quantity of cationic species generated and the radiation dose of light have positive correlation. Nevertheless, the cationic polymerization reaction itself has nothing to do with light but is affected by temperature. That is why the cationic polymerization reaction slows down at low temperatures but speeds up at high temperatures. By utilizing this phenomenon, irradiating the Composition (X) with light at low temperatures allows the Composition (X) to stay primarily cured for a longer time. In addition, heating the members after the members have been attached to each other allows the curing time to be shortened. The mechanism that causes the Composition (X) according to this embodiment to exhibit slow curing properties is presumed to be as follows:

When the Composition (X) absorbs light, a cationic species originating from the photo cation generator (Component (C)) is generated. This cationic species reacts with the monofunctional epoxy compound (Component (A)) and the monofunctional oxetane compound (Component (F)) to initiate the cationic polymerization reaction. The Component (A) has one epoxy group per molecule, and is not crosslinked three-dimensionally as a result of the cationic polymerization reaction. The Component (F) has an oxetane ring per molecule, and is not crosslinked three-dimensionally as a result of the cationic polymerization reaction. Thus, for a certain period of time since the Composition (X) has been irradiated with light, only the Components (A) and (F) react and no crosslinking reaction occurs. That is to say, the Composition (X) is not cured completely. Therefore, the modulus of elasticity of the Composition (X) that has turned primarily cured as a result of the cationic polymerization reaction of the acrylic compound hardly increases. That is why the Composition (X) appears to stay primarily cured. Thereafter, as the cationic polymerization reaction of the polyfunctional epoxy compound (Component (B)) and the polyfunctional oxetane compound (Component (H)) proceeds to make the crosslinking reaction proceed as well, the modulus of elasticity of the Composition (X) keeps increasing. Meanwhile, the cationic species reacts with the Components (B) and (H) to cause the cationic polymerization reaction as well. The Component (B) has two or more epoxy groups per molecule, and therefore, forms a three-dimensional crosslinking structure as a result of the cationic polymerization reaction. The Component (H) has two or more oxetane rings per molecule, and therefore, forms a three-dimensional crosslinking structure as a result of the cationic polymerization reaction. Thus, when a certain period of time passes since the Composition (X) has been irradiated with light, the Composition (X) turns cured completely.

Note that compositions with such slow curing behavior have been known in the art. However, the known slow curing compositions make a polyether-based or thioether-based slow curing agent trap a cationic species originating from the photo cation generator, thus delaying the timing when the cationic polymerization reaction starts. The Composition (X) controls the polymerization reaction itself, i.e., the growth reaction, not the timing when the cationic polymerization reaction starts, which is a major difference from the known slow curing composition.

In addition, once irradiated with light, the Composition (X) initiates the radical polymerization reaction and cationic polymerization reaction described above, and the cationic polymerization reaction proceeds spontaneously. Thus, the Composition (X) needs to be irradiated with light only once for a short period of time, and does not have to be irradiated with light continuously until the Composition (X) is cured. Furthermore, to cure the Composition (X), the Composition (X) does not have to be subjected to a plurality of treatments using ultraviolet radiation and heat or ultraviolet radiation and moisture, respectively. The mechanism that causes the cationic polymerization reaction to proceed spontaneously is presumed to be as follows:

The Components (A1) and (B1) contained in the Composition (X) each have a polyether skeleton in their molecule. Therefore, if a polyether skeleton and a cationic species are present, then the polyether skeleton and the cationic species are associated or liberated with/from each other according to the concentration of the liberated cationic species following the Le Chatelier's principle. That is to say, when a lot of cationic species are present in the Composition (X), the equilibrium is biased toward the association side and the number of liberated cationic species decreases. On the other hand, when the number of liberated cationic species decreases, the equilibrium is biased toward the liberation side and some liberated cationic species are supplied.

In general, when the Component (C) absorbs light, a cationic species is generated. The cationic species reacts with the Components (A) and (F) to cause a cationic polymerization reaction. In this case, if there are a lot of cationic species, the cationic polymerization reaction speeds up. On the other hand, if there are a small number of cationic species, then the cationic polymerization reaction slows down.

Right after the Composition (X) has been irradiated with light, a lot of cationic species are generated from the Component (C). Some of these cationic species are consumed by the cationic polymerization reaction between the Components (A) and (F), while the other cationic species are associated with the polyether skeleton. When the cationic polymerization reaction stops, the number of cationic species in the Composition (X) decreases. Thus, the association-liberation equilibrium between the polyether skeleton and the cationic species is biased toward the liberation side such that new cationic species are supplied to the Composition (X). These new cations species keep the cationic polymerization reaction continued. As a result, even after the Composition (X) has been irradiated with light, the cationic polymerization reaction proceeds spontaneously.

Meanwhile, the association and liberation of the polyether skeleton and cationic species proceed no matter whether or not the Composition (X) is irradiated with light. Therefore, even after the Composition (X) has been irradiated with light, the loss of activity causes a decrease in cation concentration, thus requiring supply of new cations and causing the cationic polymerization reaction to proceed. As a result, the Composition (X) is kept primarily cured for a certain period of time after having been irradiated with light, and then completely cured even without being irradiated with light or heated. Right after having been irradiated with light, the Composition (X) comes to have a steeply increased viscosity to turn primarily cured. After that, however, the viscosity rises more gently, keeping the Composition (X) primarily cured for a long time. This ensures a long pot life for bonding the members together, thus making the Composition (X) very easy to handle.

In addition, the Composition (X) contains the Components (A1) and (B1). Thus, this reduces, even after the Composition (X) has been cured, the chances of the polyether skeleton being bred out (i.e., oozing out or surfacing of the polyether skeleton onto the surface of the cured product of the Composition (X)). If a compound other than the epoxy compound with the polyether skeleton is adopted, then the compound with the polyether skeleton will be incorporated less easily into the cured product of the Composition (X), thus making the compound with the polyether skeleton easily dissociated from the three-dimensional mesh structure of the cured product. This allows the compound with the polyether skeleton to be bred out easily.

In addition, the Composition (X) contains a polyfunctional oxetane compound (as Component (H)), which allows its viscosity to increase steeply when the Composition (X) starts to cure secondarily. The mechanism is presumably as follows:

In the cationic polymerization reaction of an epoxy compound, a chain transfer of the cationic species may make the cationic species transferred into a molecule, thus possibly bringing the reaction to a halt. The chain transfer of cationic species often occurs in the epoxy compound but rarely occurs in the Component (H). Thus, the Composition (X) containing the Component (H) reduces the chances of the cationic polymerization reaction coming to a halt due to the chain transfer. This allows the Composition (X) to have its viscosity increased steeply. That is to say, the Composition (X), containing the Components (A1), (B1), and (F), may have its viscosity gently increased initially to be kept primarily cured for a predetermined amount of time and then may have its viscosity increased steeply by the Component (H). This ensures a pot life and shortens the amount of time it takes to ensure a sufficient adhesive strength that allows subsequent process steps to be performed smoothly (curing completion period).

The Composition (X) described above may be controlled to have a desired curing property (in terms of the duration for which the Composition (X) stays primarily cured and the curing completion period) by changing the blending ratio and types of the respective Components (A), (B), (C), (D), (E), (F), (G), and (H).

The duration for which the Composition (X) stays primarily cured varies according to the chemical makeup of the Composition (X), the radiation dose of light, the temperature of the Composition (X), or any other parameter. For example, the reaction rate of the cationic polymerization reaction may be increased by increasing the radiation dose of light or raising the temperature of the Composition (X) being irradiated with light. Alternatively, the reaction rate of the cationic polymerization reaction may also be decreased by decreasing the radiation dose of light or lowering the temperature of the Composition (X) being irradiated with light. Thus, the duration for which the Composition (X) stays primarily cured and the curing completion period are controllable arbitrarily by adjusting the radiation dose of light or the temperature of the Composition (X) being irradiated with light. Optionally, the duration for which the Composition (X) stays primarily cured may also be designed to fall within a predetermined range by measuring the viscoelasticity of the Composition (X).

If the Composition (X) contains radical curing components including the Components (D) and (E) and cationic curing components including the Components (A), (B), (C), (F), and (H), too much radical curing components contained in the Composition (X) would inhibit the reaction between the cationic species required for cationic curing, thus making the Composition (X) cured insufficiently. Therefore, the blending ratio of the cationic curing components to the radical curing components needs to be adjusted appropriately so that more cationic curing components are contained than the radical curing components. Specifically, the ratio by mass of the cationic curing components to the radical curing components suitably falls within the range from 55:45 to 90:10. In addition, the Component (E) works only during the radical polymerization of radical curing components while the Composition (X) is being irradiated with light, and therefore, should not be added more than required. The ratio by mass of the Component (E) to the Component (D) suitably falls within the range from 0.5% by mass to 5% by mass. When added to such a content falling within the range from 0.5% by mass to 5% by mass, the radical polymerization reaction at the time of primary curing allows the radical curing components to be reacted sufficiently, and also allows the secondary curing to be completed within a predetermined period of time without inhibiting the reaction of the radical curing components. In that case, the content of the photo cation generator is smaller than in a situation where only the cationic curing is allowed to be produced, thus reducing the corrosion of the electrodes. Nevertheless, since a strong acid is generated during the reaction process, it is very effective to add a coupling agent and use a borate-based photo cation generator and the coupling agent in combination as a countermeasure against the corrosion of the electrodes.

According to this embodiment, even if the Composition (X) contains no Component (A) at all, the Composition (X) may also be given slow curing properties effectively by adding (F) the monofunctional oxetane compound thereto. This is because the monofunctional oxetane compound has a lower initial reaction rate than the monofunctional epoxy compound. This allows the increase in the viscosity of the Composition (X) that has been irradiated with light to be reduced so significantly that the pot life, enabling the members to be attached to each other with the adhesive in the liquid state, can be kept long enough even after the Composition (X) has been irradiated with light. In addition, if the epoxy component of either the Component (A) or the Component (B) includes an ether bond, then the Composition (X) may be kept primarily cured for a very long time by using the ether bond in combination with (F) the monofunctional oxetane compound. In addition, using (H) the polyfunctional oxetane compound as an additional component allows the viscosity of the Composition (X) to be increased steeply after a predetermined amount of time has passed, thus shortening the amount of time it takes for the Composition (X) to be completely cured. That is to say, using, in combination, (F) the monofunctional oxetane compound and (H) the polyfunctional oxetane compound gives the Composition (X) effective slow curing properties.

Furthermore, if the Composition (X) contains neither (E) photo-radical generator nor (D) acrylic compound, the primarily cured Composition (X) has no ability to maintain its shape but is kept in liquid form. Adding a spacer for protecting the shape of the applied resin to an application member may allow the members to be attached to each other with a uniform thickness. Consequently, a slow-curing photocurable resin composition to be cured completely in a short time thanks to a steep increase in viscosity due to the presence of (H) the polyfunctional oxetane compound may be obtained. In that case, however, the Composition (X) is still in a completely liquid state at the time of attaching, and therefore, a jig for maintaining the attaching state and/or some amount of time to express the adhesive strength would be required.

However, if the Composition (X) contains (E) the photo-radical generator and (D) the acrylic compound, then the Composition (X) may be kept primarily cured as described above. Thus, the Composition (X) is able to maintain its shape and exhibit tackiness at the time of attaching. The Composition (X) is able to keep the members attached to each other unless some force equal to or greater than predetermined force is applied before the Composition (X) is completed cured (or secondarily cured). The photo-radical generator and the acrylic compound may turn the Composition (X) into a primarily cured product. Either (F) the monofunctional oxetane compound or (A) the monofunctional epoxy compound may delay the secondary curing time of the Composition (X) while allowing the Composition (X) to maintain tackiness. Eventually, (H) the polyfunctional oxetane compound may cause steep secondary curing to control the amount of time it takes for the Composition (X) to be completely cured. Thus, the Composition (X) containing (E) the photo-radical generator, (D) the acrylic compound, (F) the monofunctional oxetane compound, and (H) the polyfunctional oxetane compound may have the members attached to each other easily, may be reworked, and may have the amount of time to be completely cured controlled, and therefore, is highly productive.

3. Adhesive

The Composition (X) may be used as an adhesive. In particular, the Composition (X) may be used as an adhesive for bonding an optical system member for use in smartphones and cellphones. Optionally, the adhesive may be prepared by diluting the Composition (X) with an appropriate solvent. Also, when a member other than an optical system member needs to be bonded, coloring of the Composition (X) does not have to be considered so seriously. An adhesive containing (E) the photo-radical generator, (D) the acrylic compound, (F) the monofunctional oxetane compound, and (H) the polyfunctional oxetane compound is able to maintain its shape and exhibit tackiness by being irradiated with light only once, and then will be cured as it is. Thus, the adhesive is very effectively applicable to bonding members which are located in either a dark place or a place that light for curing is unable to reach for having been subjected to weather resistance treatment. In addition, this adhesive is cured with light, and therefore, is applicable particularly effectively to members to which heat may not be applied.

4. Implementations of Photocurable Resin Composition

A photocurable resin composition according to this embodiment has the following implementations:

A first implementation of a photocurable resin according to this embodiment composition is to be cured when exposed to light, and contains: (B) 10 parts by mass to 95 parts by mass of a polyfunctional epoxy compound; and (F) 5 parts by mass to 90 parts by mass of a monofunctional oxetane compound.

A second implementation of a photocurable resin composition according to this embodiment, which may be adopted in conjunction with the first implementation, further contains (H) a polyfunctional oxetane compound. The total content of (B) the polyfunctional epoxy compound and (H) the polyfunctional oxetane compound falls within a range from 10 parts by mass to 95 parts by mass.

In a third implementation of a photocurable resin composition according to this embodiment, which may be adopted in conjunction with the second implementation, the content of (H) the polyfunctional oxetane compound falls within a range from 1 part by mass to 30 parts by mass.

In a fourth implementation of a photocurable resin composition according to this embodiment, which may be adopted in conjunction with any one of the first to third implementations, (B) the polyfunctional epoxy compound contains a bifunctional epoxy resin.

A fifth implementation of a photocurable resin composition according to this embodiment, which may be adopted in conjunction with any one of the first to fourth implementations, further contains (D) an acrylic compound.

A sixth implementation of a photocurable resin composition according to this embodiment, which may be adopted in conjunction with the fifth implementation, further contains (A) a monofunctional epoxy compound. The ratio by mass of the total content of (A) the monofunctional epoxy compound and (B) the polyfunctional epoxy compound to the content of (D) the acrylic compound falls within a range from 5:95 to 90:10.

A seventh implementation of a photocurable resin composition according to this embodiment is having a property of being cured when exposed to light, and contains: either (A) a monofunctional epoxy compound or (F) a monofunctional oxetane compound, or both of these compounds (A) and (F); (B) a polyfunctional epoxy compound; (C) a photo cation generator, and (I) a coupling agent. In this implementation, (I) the coupling agent contains (i) a silane coupling agent having an organic functional group, of which a linear carbon chain has a carbon number of two or less.

In an eighth implementation of a photocurable resin composition according to this embodiment, which may be adopted in conjunction with the seventh implementation, (i) the silane coupling agent having the organic functional group, of which the linear carbon chain has a carbon number of two or less, contains at least one silane coupling agent selected from the group consisting of two silane coupling agents expressed by the chemical structural formulae (i-1) and (i-2).

In a ninth implementation of a photocurable resin composition according to this embodiment, which may be adopted in conjunction with the seventh or eighth implementation, the content of (i) the silane coupling agent, having the organic functional group, of which the linear carbon chain has a carbon number of two or less, is equal to or greater than 0.01 parts by mass relative to the total of 100 parts by mass.

In a tenth implementation of a photocurable resin composition according to this embodiment, which may be adopted in conjunction with any one of the seventh to ninth implementations, (C) the photo cation generator contains a photo cation generator of a borate salt type.

An eleventh implementation of a photocurable resin composition according to this embodiment is having a property of being cured when exposed to light, and contains: either (A) a monofunctional epoxy compound or (F) a monofunctional oxetane compound, or both of these compounds (A) and (F); (B) a polyfunctional epoxy compound; and (C) a photo cation generator. In this implementation, (B) the polyfunctional epoxy compound contains (B3) a polyfunctional epoxy compound treated by hydrogenation reaction.

A twelfth implementation of a photocurable resin composition according to this embodiment is having a property of being cured when exposed to light, and contains: either (A) a monofunctional epoxy compound or (F) a monofunctional oxetane compound, or both of these compounds (A) and (F); (B) a polyfunctional epoxy compound; (C) a photo cation generator; and (G) an elastomer. In this implementation, (G) the elastomer contains (G2) an elastomer treated by hydrogenation reaction.

In a thirteenth implementation of a photocurable resin composition according to this embodiment, which may be adopted in conjunction with the twelfth implementation, (B) the polyfunctional epoxy compound contains (B3) a polyfunctional epoxy compound treated by hydrogenation reaction.

A fourteenth implementation of a photocurable resin composition according to this embodiment, which may be adopted in conjunction with any one of the eleventh to thirteenth implementations, further contains (H) a polyfunctional oxetane compound.

In a fifteenth implementation of a photocurable resin composition according to this embodiment, which may be adopted in conjunction with any one of the eleventh to fourteenth implementations, at least one compound selected from the group consisting of (A) the monofunctional epoxy compound, (F) the monofunctional oxetane compound, and (H) the polyfunctional oxetane compound further contains a compound treated by hydrogenation reaction.

A sixteenth implementation of a photocurable resin composition according to this embodiment, which may be adopted in conjunction with any one of the eleventh to fifteenth implementations, further contains (D) an acrylic compound.

In a seventeenth implementation of a photocurable resin composition according to this embodiment, which may be adopted in conjunction with the sixteenth implementation, the ratio by mass of the total content of (A) the monofunctional epoxy compound and (B) the polyfunctional epoxy compound to the content of (D) the acrylic compound falls within a range from 5:95 to 90:10.

In an eighteenth implementation of a photocurable resin composition according to this embodiment, which may be adopted in conjunction with any one of the eleventh to seventeenth implementations, the content of a compound not treated by the hydrogenation reaction and having no double bonds is equal to or greater than 50% by mass and the content of a compound treated by the hydrogenation reaction is equal to or greater than 20% by mass.

5. First Embodiment of Stacked Structure and Method for Fabricating the Structure

5-1. Overview of this Embodiment

A stacked structure according to this embodiment includes: a cured product of an adhesive containing the Composition (X); a first member; and a second member. The first member and the second member are fixed together with the cured product.

A method for fabricating a stacked structure according to this embodiment includes: an arrangement step of arranging an uncured coating of the adhesive on at least one member selected from the group consisting of a first member and a second member; an irradiation step of irradiating the uncured coating with an active energy ray (such as an ultraviolet ray) after the arrangement step has been performed; a positioning step of positioning the first member and the second member with the uncured coating interposed after the irradiation step has been performed; and a curing step of fixing the first member and the second member together by completely curing the uncured coating after the positioning step has been performed.

Also, irradiating the uncured coating with the active energy ray suitably causes a radical polymerization reaction between the Components (D) and (E) in the irradiation step to turn the uncured coating primarily cured, keeps the uncured coating primarily cured in the positioning step, and causes a cationic polymerization reaction between the Components (A), (B), (C), and (F) in the curing step to have the uncured coating completely cured.

A stacked structure according to this embodiment is suitably fabricated by the following method.

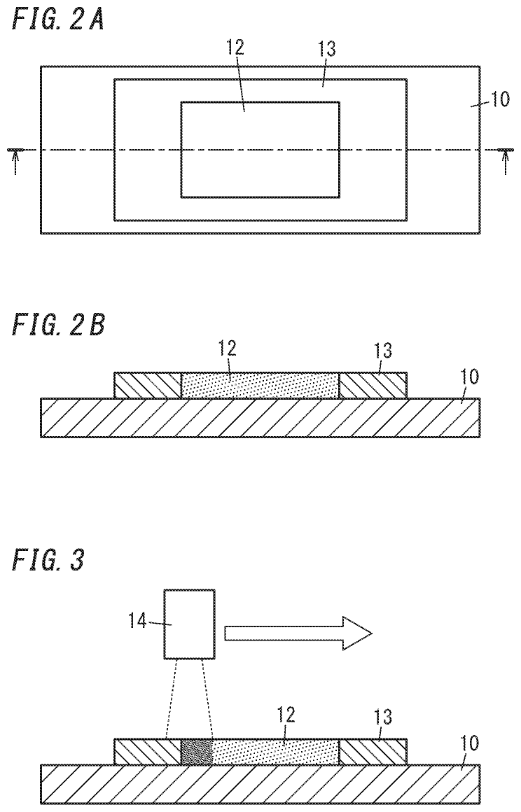

A method for fabricating the stacked structure 1 shown in FIG. 6 will be described with reference to FIGS. 2A-5. This stacked structure 1 includes a first member 10, a second member 11, and a cured product 20 of an adhesive containing the Composition (X).

5-2 Description of Adhesive

An adhesive according to this embodiment is in liquid form before being irradiated with an active energy ray and will turn, when applied as an adhesive coating onto a given member, into a shape conforming to that of the given member. This reduces the chances of air bubbles entering the gap between the given member and the coating.

In addition, while being irradiated with an active energy ray, the adhesive coating has a storage modulus higher than a loss modulus (due to primary curing) and comes to have decreased flowability. This allows the adhesive to maintain the coating shape and reduces the deformation of the coating when the members are attached to each other. This reduces the overflow of the adhesive. Besides, the adhesive coating's ability to turn into any arbitrary shape makes the adhesive applicable to attaching even members with a complex shape.

Furthermore, the adhesive starts curing (i.e., secondary curing) when a predetermined amount of time passes since the adhesive was irradiated with an active energy ray and then is completely cured (i.e., complete curing). Thus, after having been attached to each other with the adhesive coating, a plurality of members will be fixed together. This allows the plurality of members to be fixed together without being affected by the optical transmittance of the members, and reduces the chances of causing resin leakage due to insufficient curing of the adhesive. This reduces the chances of other members being contaminated with the resin leakage.

Moreover, once irradiated with the active energy ray, the adhesive is able to go through the primary curing, secondary curing, and complete curing. Thus, the adhesive to be cured does not have to go through a plurality of treatments using either ultraviolet radiation and heat or ultraviolet radiation and moisture in combination.

5-3. Arrangement Step

First of all, an uncured coating 12 of an adhesive is arranged on at least one of the first member 10 or the second member 11. That is to say, the coating 12 may be provided on the first member 10, on the second member 11, or on both of the first and second members 10 and 11. The coating 12 may be formed by applying the adhesive onto at least one of the first member 10 or the second member 11. The amount of the adhesive applied suitably falls within the range from 5 mg/cm² to 50 mg/cm². This facilitates attaching a plurality of members to each other and also allows the coating to be cured sufficiently. The shape of the coating is not particularly limited, and may be rectangular or linear, for example. In FIGS. 2A and 2B, a frame 13 is arranged on the first member 10 and the adhesive is supplied into the frame 13 to form the uncured coating 12.

5-4. Irradiation Step

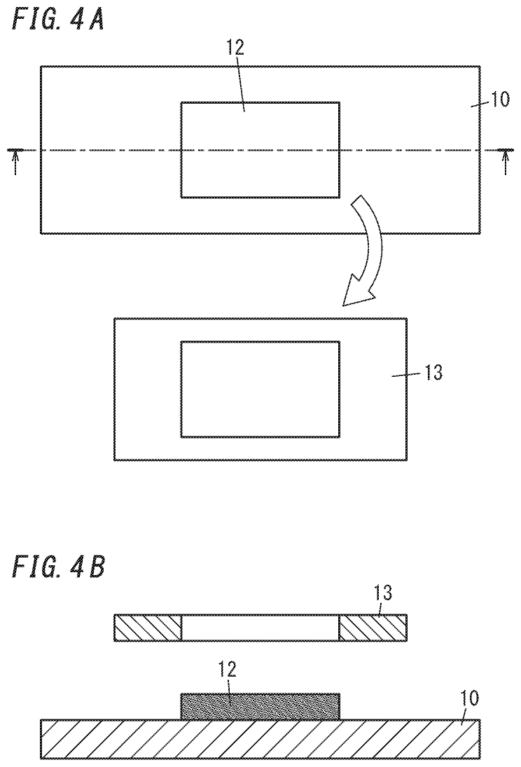

After the arrangement step has been performed, the cured coating 12 is irradiated with an active energy ray, thus turning the coating 12 primarily cured. The primarily cured coating 12 has tackiness. A light source 14 for the active energy ray is not particularly limited, but may be an ultraviolet lamp, for example. The active energy ray is suitably radiated at a radiation dose falling within the range from 50 mJ/cm² to 30000 mJ/cm². This reduces the chances of the cationic polymerization reaction stopping halfway to make the adhesive cured insufficiently. The radiation duration of the active energy ray is suitably appropriately adjusted according to the conditions including the temperature, the thickness of the coating, and the radiation dose. In FIG. 3, the uncured coating 12 arranged in the frame 13 is irradiated with the active energy ray emitted from the light source 14. The light source 14 irradiates the entire coating 12 with the active energy ray while moving in the direction indicated by the arrow in FIG. 3. This allows the coating 12 to be formed in a sheet shape. The sheet-shaped coating 12 is applicable to bonding a cover panel with a button hole or a camera hole or base members not having a simple square shape called a “free form.” After the coating 12 has turned primarily cured, the frame 13 is removed as shown in FIGS. 4A and 4B. If the coating is able to maintain the as-applied shape for a certain amount of time by adjusting the viscosity with an elastomer, for example, then the coating that has just been applied may be irradiated with the active energy ray. This makes the thickness at the time of attaching controllable.

5-5. Positioning Step

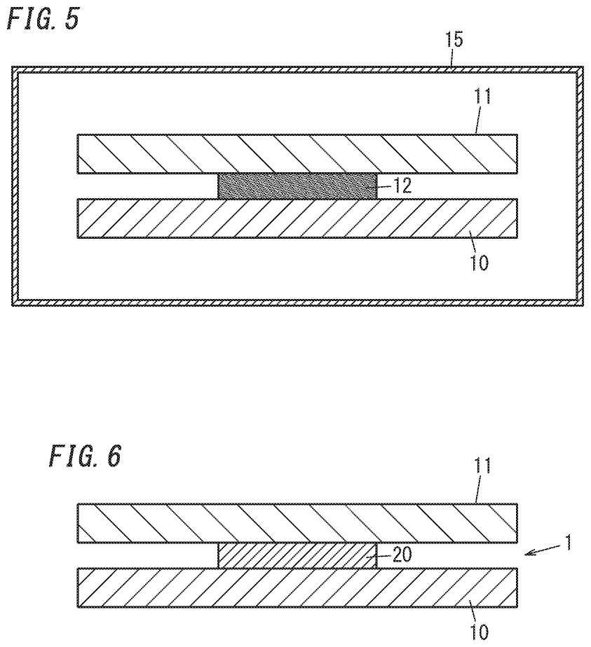

After the irradiation step has been performed, the first member 10 and the second member 11 are attached to each other with the uncured coating 12. At this time, the coating 12 is kept primarily cured, and therefore, is able to maintain its shape easily. This reduces the chances of the coating 12 being deformed while the first member 10 and the second member 11 are being transported. In addition, this also reduces the chances of the adhesive overflowing while the first member 10 and the second member 11 are being attached to each other. Furthermore, this also allows the first member 10 and the second member 11 to be attached to each other accurately. In FIG. 5, the first member 10 and the second member 11 that have been attached to each other with the coating 12 is arranged in a vacuum chamber 15. Reducing the pressure in the vacuum chamber 15 in such a state allows the first member 10 and the second member 11 to be adhered tightly to each other. This reduces the chances of the adhesiveness decreasing by air bubbles entering the gap between the first member 10 and the second member 11. After the first member 10 and the second member 11 have been positioned in this manner, the assembly of the first member 10 and the second member 11 is unloaded from the vacuum chamber 15.

5-6. Curing Step

After the positioning step has been performed, the coating 12 is cured completely, thus fixing the first member 10 and the second member 11 together. Specifically, the primarily cured coating 12 is cured by having its viscosity increased steeply to form a cured product 20 of the adhesive. This cured product 20 fixes the first member 10 and the second member 11 together. In this curing step, curing of the coating 12 proceeds spontaneously even without any additional treatment such as irradiation with an ultraviolet ray or application of heat or moisture. That is to say, irradiation with the active energy ray needs to be performed only once before the positioning step is performed. Therefore, the first member 10 and the second member 11 may be fixed together without being affected by the shape, optical transmittance, or any other parameter of the first member 10 and the second member 11. In addition, this also reduces the chances of other members being contaminated with resin leakage.

The stacked structure 1 shown in FIG. 6 is obtained by performing these arrangement, irradiation, positioning, and curing steps. This stacked structure 1 includes the first member 10, the second member 11, and the cured product 20 of the adhesive. The first member 10 and the second member 11 are fixed together with the cured product 20.

5-7. Specific Exemplary Method for Fabricating Stacked Structure

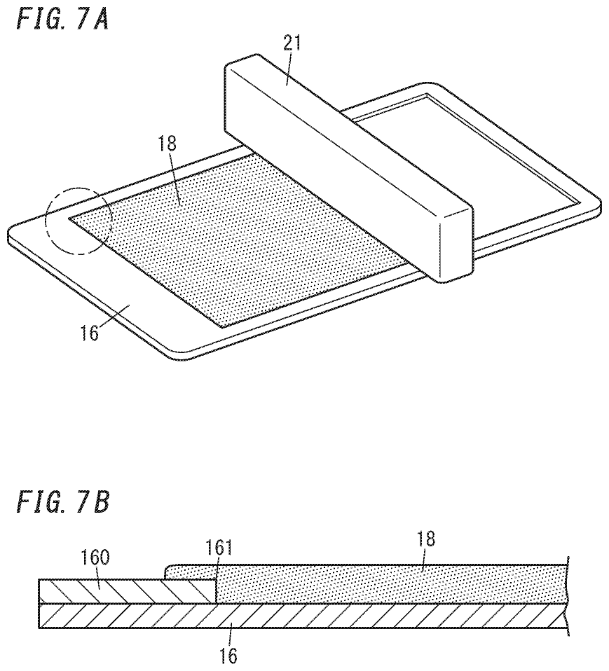

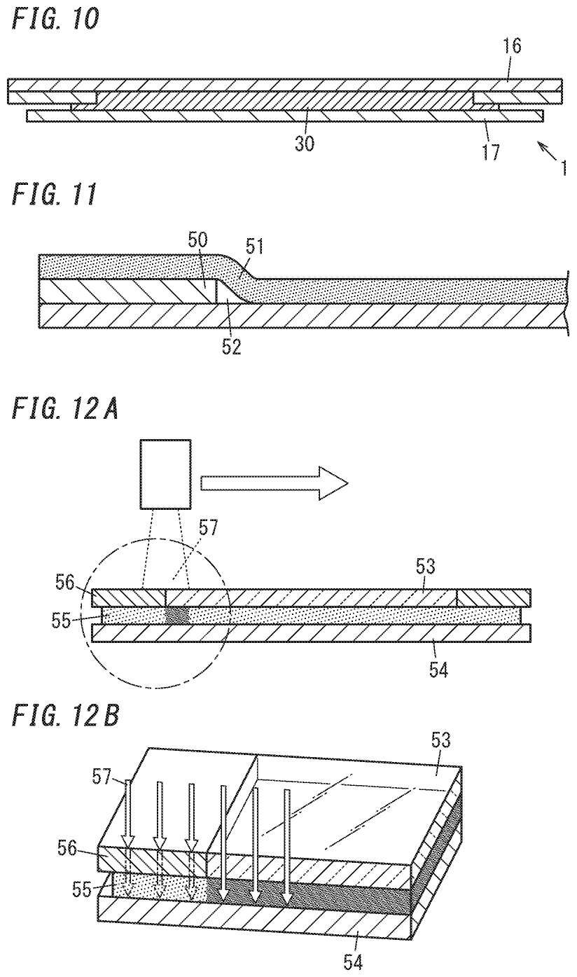

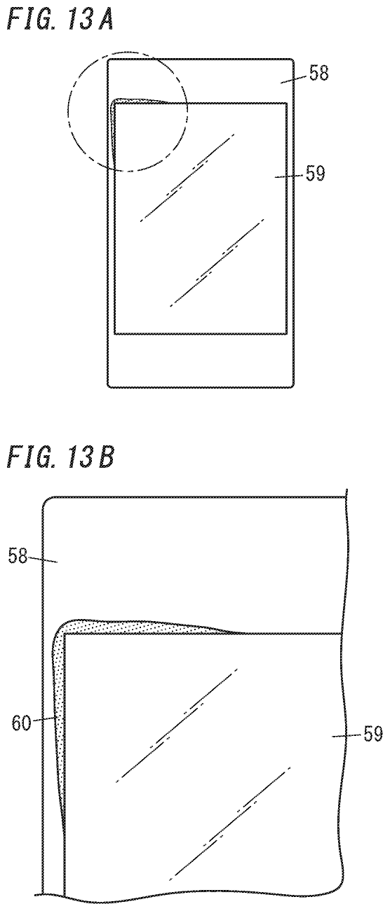

A method for fabricating the stacked structure 1 shown in FIG. 10 will be described with reference to FIGS. 7A-9. This stacked structure 1 includes a cover panel 16 as an exemplary first member, a liquid crystal panel 17 as an exemplary second member, and a cured product 30 of an adhesive containing the Composition (X).

First, as shown in FIG. 7A, a coating 18 of the adhesive is arranged on a cover panel 16 (arrangement step). Specifically, the coating 18 is formed by applying the adhesive through a dispenser 21 onto the cover panel 16. As shown in FIG. 7B, the cover panel 16 includes, at an edge portion thereof, a decorative printing portion 160, which forms a stepped portion 161. Thus, the coating 18 is provided to cover the stepped portion 161. When applied, the adhesive is in liquid form, thus reducing the chances of air bubbles entering the gap between the stepped portion 161 and the coating 18.

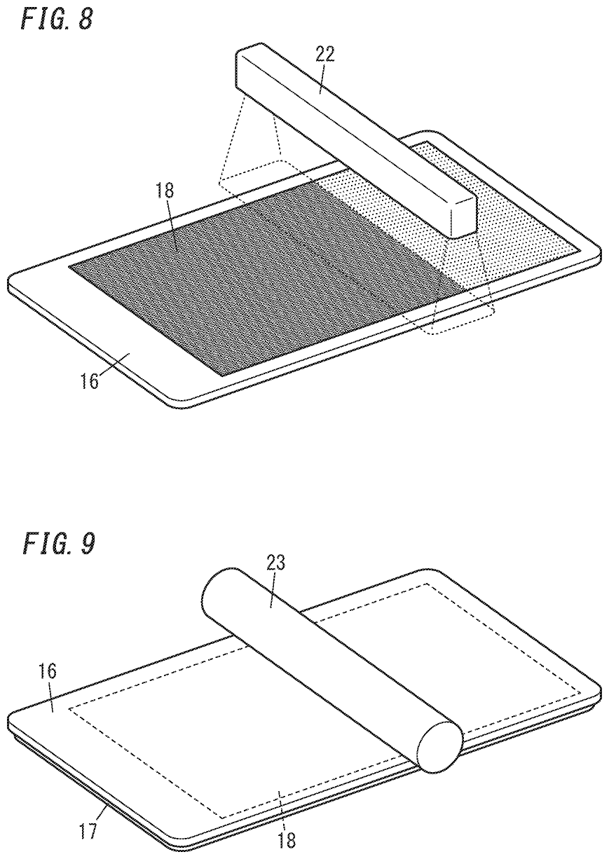

Next, as shown in FIG. 8, the coating 18 is irradiated with an active energy ray (irradiation step). Specifically, the coating 18 on the cover panel 16 is irradiated with an active energy ray emitted from a light source 22. This allows the coating 18 to turn primarily cured and exhibit tackiness.

Subsequently, as shown in FIG. 9, the cover panel 16 and the liquid crystal panel 17 are attached to each other with the coating 18 (positioning step). Specifically, the cover panel 16 shown in FIG. 8 is turned upside down, and is pressed by a roller 23 against the liquid crystal panel 17 such that the coating 18 is sandwiched between the liquid crystal panel 17 and the cover panel 16, thus attaching the cover panel 16 and the liquid crystal panel 17 to each other. In this positioning step, the coating 18 is kept primarily cured, which reduces the chances of the coating 18 being deformed while the cover panel 16 is being transported. In addition, this also reduces the chances of the adhesive overflowing while the cover panel 16 and the liquid crystal panel 17 are being attached to each other.

Thereafter, the cover panel 16 and the liquid crystal panel 17 are fixed together by allowing the coating 18 to be cured completely (curing step). Specifically, the primarily cured coating 18 is cured by having its viscosity increased steeply to form a cured product 30 of the adhesive. This cured product 30 fixes the cover panel 16 and the liquid crystal panel 17 together. The stacked structure 1 shown in FIG. 10 is formed by performing these process steps.

In the foregoing description, a stacked structure of the cover panel and the liquid crystal panel has been described as an exemplary stacked structure. However, this is only an example and should not be construed as limiting. Alternatively, the adhesive may also be used to attach a liquid crystal module and a housing to each other, for example. The liquid crystal module and the housing are directly touched and viewed by the user. Thus, the positioning accuracy at the time of attaching the liquid crystal module and the housing to each other affects the commercial value of the product.

When a housing and a liquid crystal module are attached to each other with a liquid adhesive, the thickness of the adhesive layer decreases locally and unexpectedly to prevent the height levels of the housing and the liquid crystal module from be kept consistent. Thus, in known products, a peripheral portion of the housing is provided with protrusions to keep the height levels of the liquid crystal module and the housing consistent and thereby ensure the intended product design. In contrast, the adhesive according to this embodiment is able to maintain its shape just by being irradiated with an active energy ray after having been applied. This allows the adhesive layer to have a consistent thickness and ensures an intended product design even without forming additional protrusions on the housing. Specifically, the adhesive is applied onto a portion to be attached of the housing to form a linear coating, which is allowed to turn primarily cured by going through the same irradiation step as the one described above. The adhesive is able to maintain its shape while being still primarily cured. Thus, even when the liquid crystal module is attached afterwards to the housing, the adhesive layer still maintains the uniform thickness. Consequently, this allows the housing and the liquid crystal module to be fixed together at a consistent thickness by having the adhesive cured completely. The member to be attached may have a stepped portion or a curved surface as well. Optionally, the adhesive according to this embodiment may also be used to bond a reinforcing frame for a housing to the housing and bond a protective frame for a liquid crystal layer to the liquid crystal layer.

6. Second Embodiment of Stacked Structure and Method for Fabricating the Structure

6-1. Overview of this Embodiment

A stacked structure according to this embodiment is a structure in which a first member and a second member are bonded together with an adhesive portion. The adhesive portion includes a cured product of a first adhesive and a cured product of a second adhesive. The first adhesive is a dam agent supplied in a frame shape. The second adhesive is a fill agent supplied inside of the first adhesive supplied in the frame shape. The first adhesive and the second adhesive contain a photo cationic resin composition with slow curing properties that requires a predetermined amount of time to start curing since a point in time when each of the first and second adhesives in an uncured state has just been irradiated with an active energy ray. The amount of time required by the first adhesive to start curing since the point in time when the first adhesive in the uncured state has just been irradiated with the active energy ray is shorter than the amount of time required by the second adhesive to start curing since the point in time when the second adhesive in the uncured state has just been irradiated with the active energy ray. The cured product of the first adhesive and the cured product of the second adhesive have been cured with an active energy ray that has been applied before the first member and the second member are attached to each other.

A method for fabricating a stacked structure according to this embodiment is a method for fabricating a stacked structure in which a first member and a second member are bonded together with an adhesive portion. The adhesive portion includes a cured product of a first adhesive and a cured product of a second adhesive. The first adhesive is a dam agent supplied in a frame shape. The second adhesive is a fill agent supplied inside of the first adhesive supplied in the frame shape. The first adhesive and the second adhesive contain a photo cationic resin composition with slow curing properties that requires a predetermined amount of time to start curing since a point in time when each of the first and second adhesives in an uncured state has just been irradiated with an active energy ray. The method includes: supplying the first adhesive and the second adhesive to at least one member selected from the group consisting of the first member or the second member; irradiating, with an active energy ray, the first adhesive and the second adhesive that have been supplied; and then attaching the first member and the second member to each other. The first adhesive and the second adhesive are cured by having been irradiated with the active energy ray.

Also, the first adhesive and the second adhesive are suitably cured by not only having been irradiated with the active energy ray but also having their temperature increased.

6-2. Description of Stacked Structure

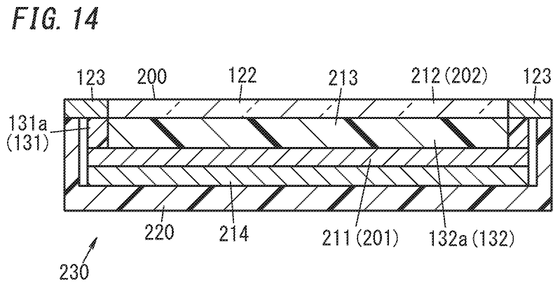

FIG. 14 illustrates a stacked structure 200 according to this embodiment. The stacked structure 200 is formed to include a first member 211, a second member 212, and an adhesive portion 213. The stacked structure 200 is formed by stacking, one on top of another in multiple layers, the first member 211 in a flat plate shape, the second member 212 in a flat plate shape, and the adhesive portion 213 in a flat plate shape. The stacked structure 200 is formed as a display device for a mobile telecommunications device such as a smartphone or a cellphone. In this case, the first member 211 is implemented as a display panel 201 and the second member 212 is implemented as a transparent plate 202.

The display panel 201 has the capability of displaying characters, images and other types of information and may be implemented as a liquid crystal display with a backlight 214 or an organic EL display, for example. The transparent plate 202 has the function of covering and protecting the display panel 201 and may be implemented as a plastic plate of polycarbonate or an acrylic resin or a glass pane. The stacked structure 1 is assembled with a housing 220 to form a mobile telecommunications device 230. In this case, the stacked structure 200 and the housing 220 are assembled together such that the display panel 201 is housed in the space in the housing 220 and that the transparent plate 202 closes the opening of the housing 220.

The first member 211 and the second member 212 do not transmit an active energy ray such as an ultraviolet ray. As used herein, if some member “does not transmit an active energy ray,” then it means that the transmittance through the member of the active energy ray that is able to cure the Composition (X) falls within the range from 0% to 5%. Meanwhile, the second member 212 includes a transparent portion 122, which has a visible light transmittance of 85% to 100%. This allows the characters, images and other information displayed on the first member 211 to be easily viewed through the transparent portion 122. The second member 212 further includes an opaque portion 123. The opaque portion 123 is the rest of the second member 212 other than the transparent portion 122, and may be provided in a frame shape along peripheral edge portions of the second member 212, for example. The opaque portion 123 has a visible light transmittance less than 85%, which is suitably 3% or less. Thus, it is virtually impossible to view, through the opaque portion 123, the characters displayed on the first member 211 or the inside of the housing 220. The opaque portion 123 may be implemented as a decorative printing layer, for example.

The adhesive portion 213 is provided between the first member 211 and the second member 212 to bond and fix the first member 211 and the second member 212 together. The first member 211 and the second member 212 are provided so as to be fixed with the adhesive portion 213 and not to be displaced or easily delaminated from each other. Specifically, the adhesive portion 213 is made up of a cured product 131a of a first adhesive 131 and a cured product 132a of a second adhesive 132.

6-3. Description of Adhesive

The first adhesive 131 and the second adhesive 132 each contain Composition (X) with slow curing properties. The Composition (X) is in liquid form right after having been irradiated with an active energy ray such as an ultraviolet ray and will be cured completely when a predetermined amount of time passes since the irradiation with the active energy ray. The Composition (X) contained in the first adhesive 131 and the Composition (X) contained in the second adhesive 132 have different curing start times. Thus, even if the first adhesive 131 and the second adhesive 132 are irradiated with the active energy ray simultaneously, the first adhesive 131 and the second adhesive 132 require different amounts of time to start curing since a point in time when the first and second adhesives 131, 132 have just been irradiated with the active energy ray. For example, the amount of time required by the first adhesive 131 to start curing since the point in time when the first adhesive 131 in the uncured state has just been irradiated with the active energy ray may be shorter than the amount of time required by the second adhesive 132 to start curing since the point in time when the second adhesive 132 in the uncured state has just been irradiated with the active energy ray. The amount of time required by the first adhesive 131 may be a half or less of the one required by the second adhesive 132. The amount of time required by the first adhesive 131 and the second adhesive 132 to start curing since the adhesives 131 and 132 have just been irradiated with the active energy ray will be hereinafter referred to as a “gelation time.” Also, the amount of time required by the first adhesive 131 and the second adhesive 132 to be completely cured since the adhesives 131 and 132 have just been irradiated with the active energy ray will be hereinafter referred to as “curing completion period.”

The Composition (X) for use as a material for the first adhesive 131 and the second adhesive 132 contains: (A) a polyfunctional epoxy compound having two or more epoxy groups per molecule; (B) a monofunctional epoxy compound having one epoxy group per molecule; and (C) a photo cation generator. In addition, the Composition (X) may contain not only these Components (A), (B), and (C) but also either (H) a polyfunctional oxetane compound or (F) a monofunctional oxetane compound or both of these Components (H) and (F). Optionally, the Composition (X) may include not only the Components (A), (B), (C), (F), and (H) but also (G) an elastomer as well. Such a Composition (X) has slow curing properties and may be used as an adhesive with slow curing properties. Optionally, the Composition (X) according to this embodiment may also contain, as needed, any of various other types of resins or additives as optional ingredients as far as the slow curing properties are not affected significantly.

6-4. Method for Fabricating Stacked Structure

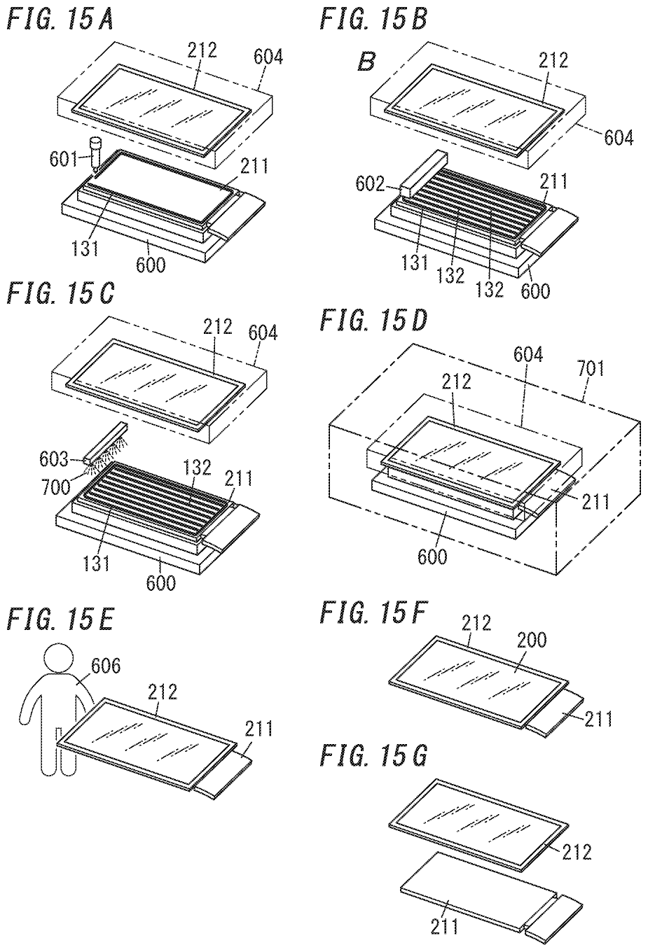

FIGS. 15A-15G illustrate a method for fabricating the stacked structure 200. According to this method, the first adhesive 131 is used as a dam agent and the second adhesive 132 is used as a fill agent. The dam agent is supplied in a frame shape onto either the first member 211 or the second member 212 in order to reduce the chances of the fill agent leaking out of the frame-shaped dam agent and to bond the first member 211 and the second member 212 together in the frame shape. The fill agent is provided to close and seal the gap between the first member 211 and the second member 212 inside of the dam agent supplied in the frame shape and thereby bond the first member 211 and the second member 212 almost in their entirety.

First, as shown in FIG. 15A, a liquid uncured first adhesive 131 is supplied onto the upper surface of the first member 211 mounted on a support 600. The first adhesive 131 may be supplied through a dispenser 601 or by any other appropriate means. Also, the first adhesive 131 is supplied in a linear shape along peripheral edge portions of the first member 211 so as to eventually form a dam in a frame shape when viewed in plan.

Next, as shown in FIG. 15B, a liquid uncured second adhesive 132 is supplied onto the upper surface of the first member 211 so as to be located inside of the first adhesive 131 that has been supplied in the frame shape. In this process step, the second adhesive 132 supplied onto the upper surface of the first member 211 is dammed by the first adhesive 131 in the frame shape so as not to leak out of the frame. The second adhesive 132 may be supplied through a dispenser 602 or by any other appropriate means. Also, the second adhesive 132 is supplied in multiple lines onto the entire upper surface of the first member 211.

Subsequently, as shown in FIG. 15C, the first adhesive 131 and the second adhesive 132 that have been supplied onto the upper surface of the first member 211 are irradiated with an active energy ray almost simultaneously. The active energy ray may be radiated through a UV ray generator 603 or any other appropriate means. The first adhesive 131 and the second adhesive 132 have slow curing properties. Thus, right after the first adhesive 131 and second adhesive 132 have been irradiated with the active energy ray (such as an ultraviolet ray) 700, their curing (gelation) does not proceed rapidly but the first adhesive 131 and the second adhesive 132 still maintain a virtually liquid form.

Thereafter, the first member 211 and the second member 212 are aligned (positioned) with each other. This alignment process is performed by turning a feeder 604 over the support 600, for example. This allows the first member 211 mounted on the support 600 to be aligned with the second member 212 held by the feeder 604.

Next, the first member 211 and the second member 212 are attached to each other in a vacuum. In this case, as shown in FIG. 15D, the first member 211 mounted on the support 600 and the second member 212 held by the feeder 508 are laid one on top of the other with the first adhesive 311 and the second adhesive 312 interposed between them and then the assembly is loaded into a vacuum chamber 701. Then, the pressure inside the vacuum chamber 701 is reduced to make the first and second members 211 and 212 tightly adhere to each other. This increases the viscosity of the first adhesive 131 to more than twice as high a level as the one before the irradiation with the active energy ray. This vacuum attaching makes the first adhesive 131 almost completely cured to form a cured product 131a, with which the first member 211 and the second member 212 are bonded together. In this process step, the temperature of the first adhesive 131 may be increased to a temperature at which its curing advances easily in order to accelerate its curing. Meanwhile, the second adhesive 132 spreads generally uniformly inside the cured product 131a in the frame shape. However, the second adhesive 132 is not cured completely yet but still in liquid form or a state with low viscosity. Thus, right after the vacuum attaching, the first member 211 and the second member 212 are only provisionally fixed with the cured product 131a so as not to be displaced from each other. Note that the uncured first adhesive 131 and the uncured second adhesive 132 are both in liquid form, and therefore, easily fill the gap between the first member 211 and the second member 212 with no air gaps left between them, even if the attaching surfaces of the first member 211 and the second member 212 have some unevenness.

Next, as shown in FIG. 15E, the first member 211 and the second member 212 that have been vacuum-attached are subjected to a quality check by a worker 606. This quality check is carried out to inspect the cured product 131a and the second adhesive 132 for any defects such as presence of any foreign matter or air bubbles. If the product under test passes the test, the product is subjected to curing. As a result of this curing, the second adhesive 132 is completely cured to form a cured product 132a. Then, the cured product 131a and the cured product 132a form an adhesive portion 213, with which the first member 211 and the second member 212 are completely fixed together to form a stacked structure 200 as shown in FIG. 15F. Optionally, during the curing process, the temperature of the second adhesive 132 may be increased to a temperature at which curing of the second adhesive 132 advances easily, in order to accelerate its curing. On the other hand, if the product turns out to be a defective product, the first member 211 and the second member 212 that have been provisionally fixed together with the cured product 131a are disassembled as shown in FIG. 15G Then, the first member 211 and the second member 212 that have been disassembled are reworked.

In the method for fabricating a stacked structure 200 according to this embodiment, the first adhesive 131 and the second adhesive 132 both have slow curing properties, and therefore, will not start curing until a predetermined amount of time passes since these adhesives 131 and 132 have just been irradiated with the active energy ray. That is to say, these adhesives 131 and 132 have a long pot life. Thus, after the first and second adhesives 131 and 132 supplied onto the first member 211 have been irradiated with the active energy ray, the first member 211 and the second member 212 may be attached to each other, and then the first adhesive 131 and the second adhesive 132 may start curing with the active energy ray that has been radiated before the first and second members 211 and 212 are attached to each other. Therefore, there is almost no need to irradiate the adhesives 131 and 132 with the active energy ray after the first member 211 and the second member 212 have been attached to each other. That is to say, this allows even the first and second members 211 and 212 that are difficult to transmit the active energy ray to be attached to each other. In addition, this facilitates alignment of the first and second members 211 and 212 that have been attached to each other, thus increasing the productivity.

In addition, the first adhesive 131 and the second adhesive 132 have different gelation times. Thus, letting only the first adhesive 131 with the shorter gelation time be cured without letting the second adhesive 132 with the longer gelation time be cured allows the first member 211 and the second member 212 to be provisionally fixed together. This allows quality check and other subsequent process steps to be performed in a state where the first member 211 and the second member 212 are not easily displaceable from each other. Besides, if any defective product has been found as a result of the quality check, the first member 211 and the second member 212 that are fixed just provisionally are easily separable from each other. This allows the first member 211 and the second member 212 to be reworked easily.

In the example described above, the first adhesive 131 and the second adhesive 132 are both supplied onto the first member 11. However, this is only an example and should not be construed as limiting. Alternatively, the first adhesive 131 and the second adhesive 132 may also be supplied to only the second member 212. Also, if the first adhesive contains (D) an acrylic resin, the first adhesive turns tacky when irradiated with an active energy ray, thus significantly reducing the chances of displacement right after the vacuum attaching. In addition, if the second adhesive contains (D) an acrylic resin, the second adhesive also turns tacky when irradiated with an active energy ray, thus substantially eliminating the chances of displacement right after the vacuum attaching. Furthermore, if the Composition (X) contains (E) a photo-radical generator and (D) an acrylic compound, then the Composition (X) may be primarily cured as described above. This allows the Composition (X) to maintain its shape and have tackiness during the bonding process step. Unless force equal to or greater than predetermined force is applied before complete curing (secondary curing), the attaching state may be maintained. Thus, after the Composition (X) has turned primarily cured with (E) the photo-radical generator and (D) the acrylic compound, the secondary curing time may be delayed with (F) the monofunctional oxetane compound or (A) the monofunctional epoxy compound with the tackiness maintained. After that, steep secondary curing may be triggered by (H) a polyfunctional oxetane compound, thus making the time to complete curing controllable. Therefore, the Composition (X) containing (E) the photo-radical generator, (D) the acrylic compound, (F) the monofunctional oxetane compound, and (H) the polyfunctional oxetane compound is easily attachable, may be reworked, and has high productivity.

Furthermore, if the Composition (X) containing (D) an acrylic resin is applied to the first adhesive, then the first adhesive includes an epoxy component and an acrylic component, and therefore, is easily compatible with the second adhesive at their interface, no matter whether the second adhesive is epoxy-based or acrylic-based. Materials with the same property are suitably selected as materials for the first adhesive and the second adhesive in order to avoid reaction inhibition at the interface.

6-5. Description of Known Method for Fabricating Stacked Structure

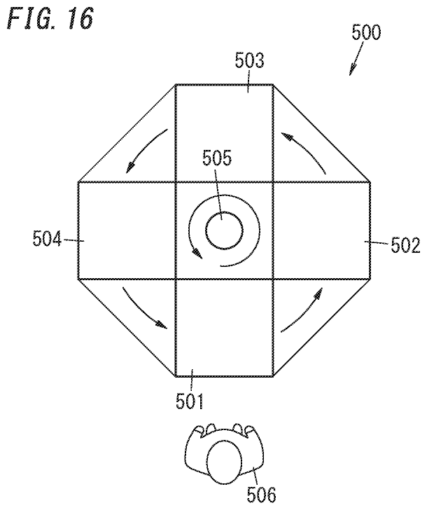

A system for fabricating a stacked structure by attaching a display device such as a liquid crystal panel and a transparent cover to each other has been proposed in the art (see, for example, JP 2015-193004 A). FIG. 16 illustrates an exemplary system for fabricating a stacked structure. This fabrication system 500 includes a first stage 501, a second stage 502, a third stage 503, and a fourth stage 504, which are provided to turn around a shaft 505.

The first stage 501 is a loading stage. The second stage 502 is an alignment and dam forming stage. The third stage 503 is a fill agent supply stage. The fourth stage 504 is a vacuum attaching stage.

In the first stage 501, members (works) to be attached to each other by the fabrication system 500 are loaded by the worker 506. For example, a first member such as a display device is mounted on a support and a second member such as a cover is held by a feeder.

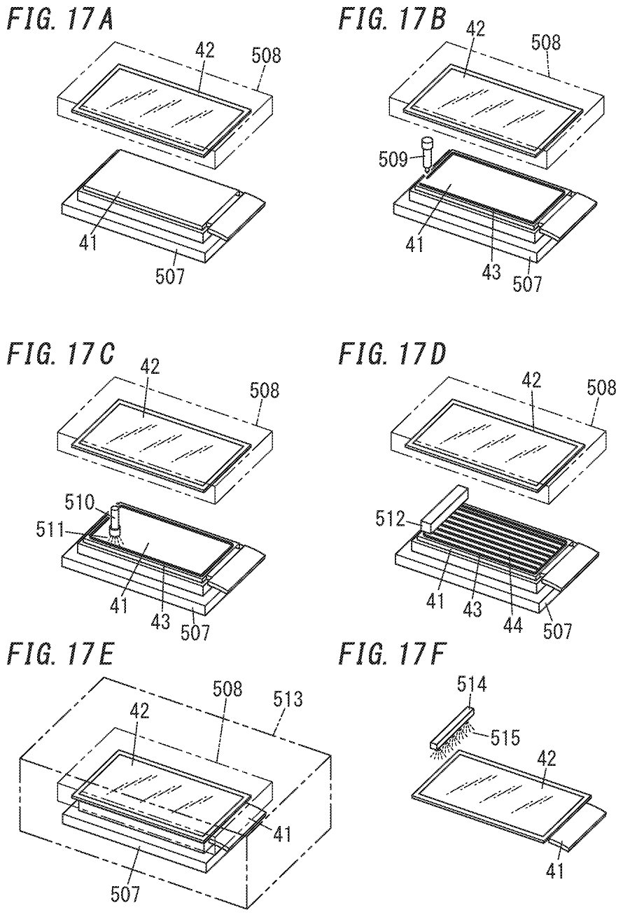

In the second stage 502, the members that have been loaded in the first stage 501 are aligned (positioned) with each other and a dam is formed. The alignment may be performed by turning a feeder 508 over a support 507 as shown in FIG. 17A. This allows the first member 41 mounted on the support 507 to be aligned with the second member 42 held by the feeder 508. Next, a dam agent is supplied. The dam agent may be a liquid ultraviolet curable resin composition, for example. The dam agent 43 may be supplied from a dam agent supplier 509 onto an attaching surface (upper surface) of the first member 41 on the support 507 so as to form a frame thereon as shown in FIG. 17B. Next, the dam agent 43 is semi-cured. In this process step, the dam agent 43 supplied onto the first member 41 is irradiated with an ultraviolet ray 511 radiated from an ultraviolet ray radiator 510 as shown in FIG. 17C. This allows the dam agent 43 to be semi-cured to the point of preventing a fill agent 44 (to be described later) from leaking out.

In the third stage 503, the fill agent 44 is supplied after the second stage 502. The fill agent 44 may be a liquid ultraviolet curable resin composition, for example. As shown in FIG. 17D, the fill agent 44 is supplied from a fill agent supplier 512 onto an attaching surface (upper surface) of the first member 1 on the support 507 inside the semi-cured dam agent 43 in the frame shape.

In the fourth stage 504, vacuum attaching is performed after the third stage 503. In this case, the first member 41 mounted on the support 507 and the second member 42 held by the feeder 508 are laid one on top of the other with the dam agent 43 and the fill agent 44 interposed between them. Then, the assembly is loaded into a vacuum chamber 513 as shown in FIG. 17E, and the first member 41 and the second member 42 are stacked one on top of the other so as to tightly adhere to each other with the pressure inside the vacuum chamber 513 reduced.

Thereafter, the stack of the first member 41 and the second member 42 is unloaded by the worker 506 from the fabrication system 500 and subjected to a quality check. After the quality check, the stack of the first member 41 and the second member 42 is irradiated with an ultraviolet ray 515 radiated from an ultraviolet ray radiator 514 as shown in FIG. 17F. This allows the dam agent 43 and the fill agent 44 to be cured completely, thus adhering and bonding the first member 41 and the second member 42 together.

In the example of the known method described above, after the first member 41 and the second member 42 have been stacked one on top of the other, the dam agent 43 and the fill agent 44 are irradiated with an ultraviolet ray transmitted through the first member 41 or the second member 42. Thus, if the first member 41 or the second member 42 does not transmit the ultraviolet ray easily (e.g., when the second member 42 is provided with a resin cover with an ultraviolet ray absorber or with a black printing frame), it is difficult to irradiate the dam agent 43 and fill agent 44 with a sufficient quantity of ultraviolet ray transmitted through the second member 42 per unit time. This may make the dam agent 43 and the fill agent 44 cured insufficiently or it may take too long a time to have the dam agent 43 and the fill agent 44 cured, thus causing a decline in productivity.

In contrast, the embodiment described above increases the productivity of the stacked structure being fabricated as already described for Sections 6-1 to 6-4.

7. Embodiment of Display Device

7-1. Overview of this Embodiment

A display device according to this embodiment includes a backlight, a liquid crystal panel, and a cover. The liquid crystal panel and the cover are bonded together with an adhesive portion. The adhesive portion includes: a light transmitting part to transmit light coming from the backlight; and a light reducing part to transmit the light less easily than the light transmitting part. The light reducing part is provided to cover a side surface of the light transmitting part.

In a display device according to this embodiment, the light reducing part suitably has a total light transmittance of 3% or less.

In a display device according to this embodiment, the light reducing part is suitably colored.

7-2. Description of Display Device

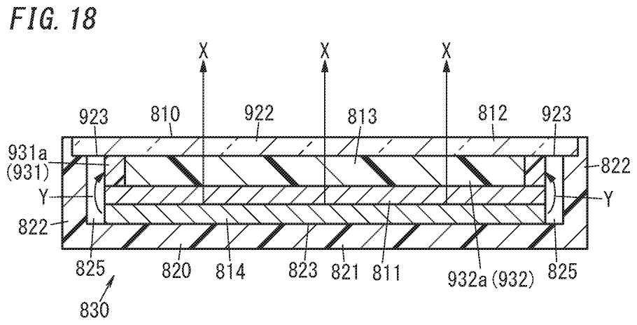

FIG. 18 illustrates a display device 830 according to this embodiment. The display device 830 is suitably used in a mobile telecommunications device such as a smartphone or a cellphone. The display device 830 includes a housing 820, a backlight 814, a liquid crystal panel 811, a cover 812, and an adhesive portion 813.

The housing 820 has a U-cross section formed by a bottom portion 821 and a sidewall portion 822. The space surrounded with the bottom portion 821 and the sidewall portion 822 is provided as chamber 823, which has an opening opposite from the bottom portion 821.

The backlight 814 is formed in a flat plate shape and is configured to emit light from light-emitting diodes (LEDs). The backlight 814 performs the function of a light source for the display device 830.

The liquid crystal panel 811 is also formed in a flat plate shape and includes a liquid crystal layer, a polarizer, a transparent electrode, a color filter, and an alignment film. The liquid crystal panel 811 performs the function of displaying characters, images, and other objects thereon.

The cover 812 is also formed in a flat plate shape and may be formed out of a plastic plate made of polycarbonate or an acrylic resin or a glass pane, for example. The cover 812 is formed almost entirely of a light-transmitting transparent portion 922. Only the lower surface of peripheral edge portions of the cover 812 is an opaque portion 923. The opaque portion 923 is arranged along the entire peripheral edges of the cover 812 and formed in a frame shape. The transparent portion 922 suitably has a visible light transmittance of 85-100%. Meanwhile, the opaque portion 23 has a visible light transmittance less than 85%, which is suitably 3% or less. In that case, characters and other objects to be displayed on the liquid crystal panel 811 or the inside of the housing 820 is hardly viewable or recognizable through the opaque portion 923. The opaque portion 923 may be implemented as a decorative printing layer, for example.

The adhesive portion 813 is also formed in a flat plate shape and is provided between the liquid crystal panel 811 and the cover 812 to bond and fix the liquid crystal panel 811 and the cover 812 together. The liquid crystal panel 811 and the cover 812 are provided to be fixed with the adhesive portion 813, i.e., so as not to be displaced or easily delaminated from each other. The adhesive portion 813 includes a light transmitting part 932a and a light reducing part 931a. The light transmitting part 932a is more transparent than, and allows the incoming light to pass more easily, than the light reducing part 931a. The light transmitting part 932a suitably has a visible light transmittance of 85-100%. Meanwhile, the light reducing part 931a is less transparent than, and allows the incoming light to pass less easily, than the light-transmitting portion 932a. The light reducing part 931a suitably has a visible light transmittance less than 85%, more suitably of 3% or less. The light reducing part 931a is provided around the entire peripheral edges of the adhesive portion 813 and formed in a frame shape. Thus, the light reducing part 931a is provided to cover the side surfaces (edge surfaces) of the light transmitting part 932a over the entire periphery of the adhesive portion 813. Therefore, the peripheral edge surfaces of the adhesive portion 813 are formed of the light reducing part 931a, thus allowing almost no incoming light to enter the adhesive portion 813 through the peripheral edge surfaces thereof. The light reducing part 931a may be colored, for example, to reduce the transmission of the incoming light. That is to say, this substantially prevents the light emitted from the backlight 814 from reaching the peripheral edge portions of the adhesive portion 813 by being bypassed through the liquid crystal panel 811. To color the light reducing part 931a, a colorant such a black pigment or dye may be added to the light reducing part 931a, for example. The colorant may selectively shield the adhesive portion 813 from light with wavelengths falling within the visible radiation range and may transmit an ultraviolet ray with a wavelength of 400 nm or less or an infrared ray with a wavelength of 700 nm or more. In that case, a wavelength selective absorbing material produced by Yamada Chemical Co., Ltd. is suitably used as the colorant. More specifically, any combination of materials with desired wavelengths may be selected as appropriate from the group consisting of a copper-porphyrin complex, a cobalt-porphyrin complex, iron oxide, copper oxide, metal phthalocyanine and azo dye. Optionally, the light reducing part 931a may also be formed to reflect incoming light and to prevent the light from reaching the peripheral edge portions of the adhesive portion 83 by adding white titanium oxide or zinc oxide thereto.

The backlight 814 is housed in the chamber 823 of the housing 820 and is put on the surface of the bottom portion 821 (i.e., the surface facing the opening of the housing 820). The liquid crystal panel 811 is also housed in the chamber 823 of the housing 820 and is put on the surface of the backlight 814 (i.e., the surface facing the opening of the housing 820). Furthermore, the adhesive portion 813 is also housed in the chamber 823 of the housing 820 and formed on the surface of the liquid crystal panel 811 (i.e., the surface facing the opening of the housing 820). The cover 812 is provided to close the opening of the housing 820 and is tightly adhered to the surface of the adhesive portion 813 (i.e., the surface facing the opening of the housing 820). In this arrangement, the transparent portion 922 of the cover 812 is laid on top of the light transmitting part 932a of the adhesive portion 813 and the opaque portion 923 of the cover 812 is located on the surface of the light reducing part 931a of the adhesive portion 813. The end portions of the cover 812 are located on the surface of the peripheral wall portions 822 of the housing 820.

In the display device 830 with such a configuration, the light emitted from the backlight 814 passes through the liquid crystal panel 811, the light transmitting part 932a of the adhesive portion 813, and the transparent portion 922 of the cover 812 in this order as indicated by the arrows X, thus allowing the viewer to normally view and recognize characters, images, and other objects displayed on the liquid crystal panel 811. Also, even if the light emitted from the backlight 814 reaches the peripheral edge surfaces of the adhesive portion 813 by being bypassed through the liquid crystal panel 811 as indicated by the arrows Y, the light reducing part 931a reduces the chances of the light entering the light transmitting part 932a of the adhesive portion 813. Therefore, this display device 830 reduces the leakage of light and allows the viewer to easily view and recognize characters, images, and other objects displayed on the liquid crystal panel 811. Note that leakage of light is produced because a gap 825 is left between the peripheral wall portions 822 of the housing 820, the end faces of the backlight 814, the end faces of the liquid crystal panel 811, and the end faces of the adhesive portion 813. This gap 825 is a space (so-called “clearance”) to facilitate housing the backlight 814 and liquid crystal panel 811 in the chamber 823. This gap 825 allows the light emitted from the backlight 814 to reach the peripheral surfaces of the adhesive portion 813.

7-3. Description of Adhesive

The adhesive portion 813 may be formed of two or more different types of adhesives. For example, the light reducing part 931a is made of a cured product of a first adhesive 931 with a low degree of transparency and the light transmitting part 932a is made of a cured product of a second adhesive 932 with transparency. To form a colored light reducing part 931a, the first adhesive 931 may contain a black or white pigment or dye. The second adhesive 932 suitably has a high degree of transparency.

The first adhesive 931 and the second adhesive 932 each include a slow curing Composition (X). The Composition (X) is liquid right after having irradiated with an active energy ray such as an ultraviolet ray and is cured completely when a predetermined amount of time passes. The Composition (X) contained in the first adhesive 931 and the Composition (X) contained in the second adhesive 932 have different curing start times. Therefore, even if the first adhesive 931 and the second adhesive 932 are irradiated with an active energy ray simultaneously, the amount of time it takes for the first adhesive 931 to start curing since the first adhesive 931 has just been irradiated with the active energy ray is different from the amount of time it takes for the second adhesive 932 to start curing since the second adhesive 932 has just been irradiated with the active energy ray. For example, the amount of time it takes for the first adhesive 931 to start curing since the first adhesive 931 has just been irradiated with the active energy ray is shorter than the amount of time it takes for the second adhesive 932 to start curing since the second adhesive 932 has just been irradiated with the active energy ray. The former may be a half or less of the latter. The amount of time it takes for the first adhesive 931 and the second adhesive 932 to start curing since the adhesives 931, 932 have just been irradiated with the active energy ray will be hereinafter referred to as a “gelation time.” The period of time it takes for the first adhesive 931 and the second adhesive 932 to be completely cured since the adhesives 931, 932 have just been irradiated with the active energy ray will be hereinafter referred to as a “curing completion period.”

The Composition (X) for use as a material for the first adhesive 931 and the second adhesive 932 contains: (A) a polyfunctional epoxy compound having two or more epoxy groups per molecule; (B) a monofunctional epoxy compound having one epoxy group per molecule; and (C) a photo cation generator. In addition, the Composition (X) may contain not only these Components (A), (B), and (C) but also either (H) a polyfunctional oxetane compound or (F) a monofunctional oxetane compound or both of these Components (H) and (F). Optionally, the Composition (X) may include not only the Components (A), (B), (C), (F), and (H) but also (G) an elastomer as well. Such a Composition (X) has slow curing properties and may be used as an adhesive with slow curing properties. Optionally, the photo cationic polymerizable composition according to this embodiment may also contain, as needed, any of various types of resins, additives or other optional ingredients as far as the slow curing properties are not affected significantly.

7-4. Method for Fabricating Display Device (Process Step of Bonding Liquid Crystal Panel and Cover)

The liquid crystal panel 811 and the cover 812 are bonded together with the adhesive portion 813 before being assembled with the housing 820. That is to say, the liquid crystal panel 811 and the cover 812 are bonded together with the adhesive portion 813 to form a stacked structure 810. Then, the stacked structure 810 is assembled with the backlight 814 and the housing 820 to form a display device 830.

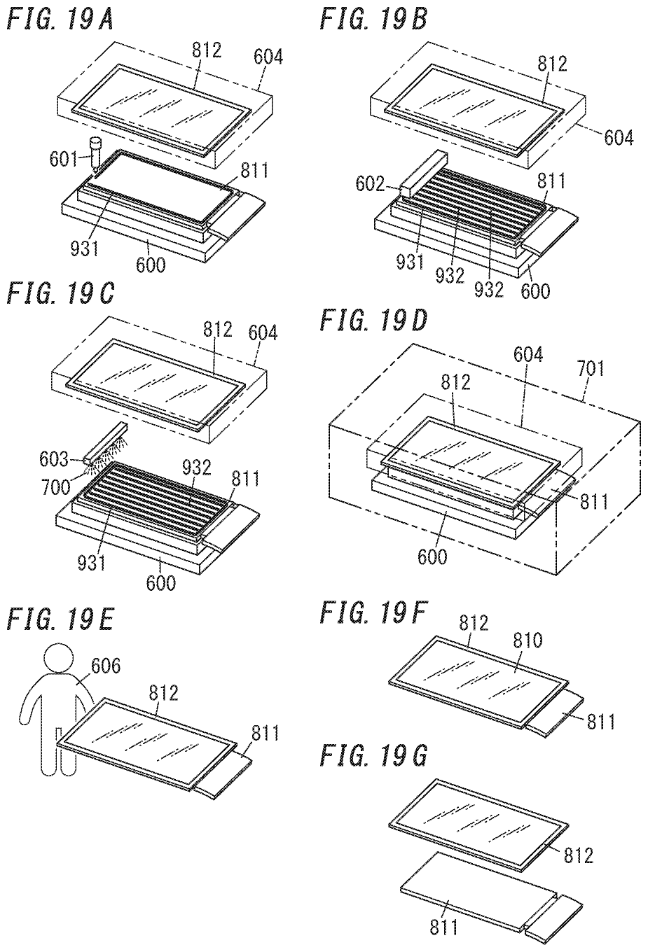

FIGS. 19A-19G illustrate the process step of bonding a liquid crystal panel and a cover together. In this bonding process step, the first adhesive 931 is used as a dam agent to be supplied in a frame shape, and the second adhesive 932 is used as a fill agent to be supplied inside of the first adhesive 931 that has been supplied in the frame shape.

First, as shown in FIG. 19A, a liquid uncured first adhesive 931 is supplied onto the upper surface of the liquid crystal panel 811 mounted on a support 600. The first adhesive 931 may be supplied through a dispenser 601 or by any other appropriate means. Also, the first adhesive 931 is supplied in a linear shape along peripheral edge portions of the liquid crystal panel 811 so as to eventually form a dam in a frame shape when viewed in plan.

Next, as shown in FIG. 19B, a liquid uncured second adhesive 932 is supplied onto the upper surface of the liquid crystal panel 811 so as to be located inside of the first adhesive 931 that has been supplied in the frame shape. In this process step, the second adhesive 932 supplied onto the upper surface of the liquid crystal panel 811 is dammed by the first adhesive 931 in the frame shape so as not to leak out of the frame. The second adhesive 932 may be supplied through a dispenser 602 or by any other appropriate means. Also, the second adhesive 932 is supplied in multiple lines onto the entire upper surface of the liquid crystal panel 811.

Subsequently, as shown in FIG. 19C, the first adhesive 931 and the second adhesive 932 that have been supplied onto the upper surface of the liquid crystal panel 811 are irradiated with an active energy ray almost simultaneously. The active energy ray may be radiated through a UV ray generator 603 or any other appropriate means. The first adhesive 931 and the second adhesive 932 have slow curing properties. Thus, right after the first adhesive 931 and second adhesive 932 have been irradiated with the active energy ray 700, their curing (gelation) does not proceed rapidly but the first adhesive 931 and the second adhesive 932 still maintain a virtually liquid form.

Thereafter, the liquid crystal panel 811 and the cover 812 are aligned (positioned) with each other. This alignment process is performed by turning a feeder 604 over the support 600, for example. This allows the liquid crystal panel 811 mounted on the support 600 to be aligned with the cover 812 held by the feeder 604.

Next, the liquid crystal panel 811 and the cover 812 are subjected to vacuum attaching. In this case, as shown in FIG. 19D, the liquid crystal panel 811 mounted on the support 600 and the cover 812 held by the feeder 604 are laid one on top of the other with the first adhesive 911 and the second adhesive 912 interposed between them and then the assembly is loaded into a vacuum chamber 701. Then, the pressure inside the vacuum chamber 701 is reduced to make the liquid crystal panel 811 and the cover 812 tightly adhere to each other while degassing their attaching surfaces. At the time of this vacuum attaching, the first adhesive 931 is cured almost completely to form the light reducing part 931a, with which the liquid crystal panel 811 and the cover 812 are attached to each other. In this process step, having the light reducing part 931a cured enables the liquid crystal panel 811 and the cover 812 to be attached to each other with the thickness of the light reducing part 931a kept consistent during the attaching process step. If the first adhesive 931 were still in an uncured liquid state, the first adhesive 931 would be pushed and leak out through the gap between the attaching surfaces during the bonding process step. Meanwhile, the second adhesive 932 spreads generally uniformly inside the light reducing part 931a in the frame shape. However, the second adhesive 932 is not cured completely yet but still in liquid form or a state with low viscosity. Thus, right after the vacuum attaching, the liquid crystal panel 811 and the cover 812 are only provisionally fixed with the light reducing part 931a so as not to be displaced from each other. Note that the uncured first adhesive 931 and the uncured second adhesive 932 are both in liquid form, and therefore, easily fill the gap between the liquid crystal panel 811 and the cover 812 with no air gaps left between them, even if the attaching surfaces of the liquid crystal panel 811 and the cover 812 have some unevenness.

Next, as shown in FIG. 19E, the assembly of the liquid crystal panel 811 and the cover 812 that have been vacuum-attached is subjected to a quality check by a worker 606. This quality check is carried out to inspect the light reducing part 931a and the second adhesive 932 for any defects such as presence of any foreign matter or air bubbles. If the product under test passes the test, the product is subjected to curing. As a result of this curing, the second adhesive 932 is completely cured to form a light transmitting part 932a. Then, the light reducing part 931a and the light transmitting part 932a form an adhesive portion 813, with which the liquid crystal panel 811 and the cover 812 are completely fixed together to form a stacked structure 810 as shown in FIG. 19F. On the other hand, if the product turns out to be a defective product, the liquid crystal panel 811 and the cover 812 that have been provisionally fixed together are disassembled as shown in FIG. 19G. Then, the liquid crystal panel 811 and the cover 812 that have been disassembled are reworked.

As described above, the first adhesive 931 and the second adhesive 932 both have slow curing properties, and therefore, will not start curing until a predetermined amount of time passes since these adhesives 931 and 932 have just been irradiated with the active energy ray. That is to say, these adhesives 931 and 932 have a long pot life. In addition, a difference in pot life between the first adhesive 931 and the second adhesive 932 ensures a sufficient thickness at the time of attaching. Thus, after the first and second adhesives 931 and 932 supplied onto the liquid crystal panel 811 have been irradiated with an active energy ray, the liquid crystal panel 811 and the cover 812 may be attached to each other, and then the first adhesive 931 and the second adhesive 932 may start curing with the active energy ray that has been radiated before the liquid crystal panel 811 and the cover 812 are attached to each other. Therefore, there is almost no need to irradiate the adhesives 931 and 932 with the active energy ray after the liquid crystal panel 811 and the cover 812 have been attached to each other. That is to say, this allows even the liquid crystal panel 811 and cover 812 that are difficult to transmit the active energy ray to be attached to each other. In addition, this facilitates alignment of the liquid crystal panel 811 and cover 812 that have been attached to each other, thus increasing the productivity.

In addition, the first adhesive 131 and the second adhesive 132 have different gelation times. Thus, letting only the first adhesive 131 with the shorter gelation time be cured without letting the second adhesive 132 with the longer gelation time be cured allows the liquid crystal panel 811 and the cover 812 to be provisionally fixed together with their thickness controlled. This allows quality check and other subsequent process steps to be performed in a state where the liquid crystal panel 811 and the cover 812 are not easily displaceable from each other. Besides, if any defective product has been found as a result of the quality check, the liquid crystal panel 811 and the cover 812 that are fixed just provisionally are easily separable from each other. This allows the liquid crystal panel 811 and the cover 812 to be reworked easily.

In the example described above, the first adhesive 931 and the second adhesive 932 are both supplied onto the liquid crystal panel 811. However, this is only an example and should not be construed as limiting. Alternatively, the first adhesive 931 and the second adhesive 932 may also be supplied to only the cover 812.

Optionally, in the embodiment described above, the first adhesive 931 may be a photo cationic polymerized product including an acrylic compound and a photo-radical generator. In that case, when the first adhesive 931 is irradiated with an active energy ray (optical energy), a radical reaction occurs instantaneously to turn the first adhesive 931 into a moderate gel. Thus, the first adhesive becomes semi-cured and comes to have its thickness controlled more easily during the attaching process step. Also, when irradiated with an active energy ray such as light, the photo cationic component starts reaction with a delay, and will be steeply cured in a predetermined amount of time to be cured completely. This allows a stacked structure to be obtained in which the two members have been attached to each other with their thickness controlled at the time of attaching, provisionally fixed together while the photo-cationic component is still not cured yet, and then fixed together with the second adhesive 932 cured. This allows the time to complete curing to be shortened by having curing done steeply after the attaching process step has been performed in an ample time, thus enabling products to be shipped in a shorter time. This allows the products in process to be kept very small in number during the in-factory process, thus cutting down the manufacturing cost.

Furthermore, in the embodiment described above, a radical polymerized compound including a radical generator and an acrylic compound may be used as the first adhesive 931. In that case, when irradiated with optical energy, the first adhesive 931 produces radical polymerization instantaneously to be cured. Meanwhile, due to the effect of oxygen in the air, the surface of the light reducing part 931a is still uncured and sticky. This allows a stacked structure to be obtained in which the two members are attached to each other with their thickness controlled at the time of attaching, provisionally fixed with tackiness resulting from the stickiness, and then fixed completely with the second adhesive 932 cured. In that case, however, the first adhesive 931 will not be completely cured and will have a low degree of reliability as it is. If the bonding surface strength required is not so high or if the first adhesive 931 is used just for controlling the attaching thickness because the stacked structure may be formed with the second adhesive 932 only, then the stacked structure may be obtained by irradiation with light only once. Nevertheless, if the first adhesive 931 needs to be cured completely, then an additional process step of irradiating the first adhesive 931 with light once again from beside the attaching surfaces, for example, needs to be performed.

7-5. Description of Known Display Device

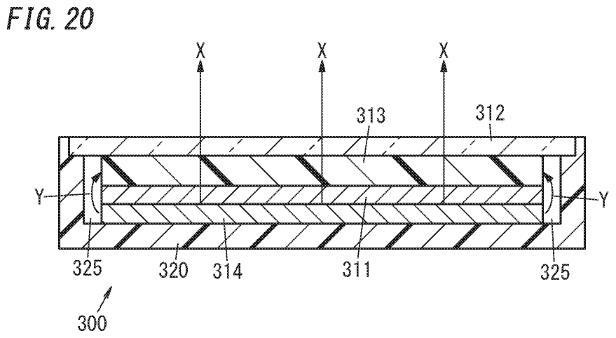

FIG. 20 illustrates an example of a known display device 300 (see, for example, JP 2015-193004 A). This display device 300 includes a backlight 314, a liquid crystal panel 311, and a transparent cover 312. The backlight 314 and the liquid crystal panel 311 are housed in a housing 320, one side of which is open, and the cover 312 is provided to close the opening of the housing 320. The backlight 314 may be made up of LEDs, for example, and the liquid crystal panel 311 is provided on the surface of the backlight 314 (i.e., the surface facing the opening of the housing 320). The liquid crystal panel 311 is formed to include a liquid crystal layer, a polarizer, a transparent electrode, a color filter, and an alignment film. The surface of the liquid crystal panel 311 (i.e., the surface facing the opening of the housing 320) is provided with a transparent adhesive portion 313, with which the cover 312 is bonded to the surface of the liquid crystal panel 311. In this display device 300, the light emitted from the backlight 314 is transmitted through the liquid crystal panel 311, the adhesive portion 313, and the cover 312 in this order, thus displaying characters, images, and other objects thereon. The normal traveling direction of light is indicated by the arrows X.

In the example of the known display device 300 described above, the light emitted from the backlight 314 may enter the adhesive portion 313 through a side surface thereof by being bypassed through the liquid crystal panel 311 (i.e., a so-called “leakage of light” may occur), thus sometimes making the characters, images, and other objects less easily viewable. The leakage of light occurs due to the presence of a gap 325 inside of the housing 320. That is to say, the leakage of light is caused by the incidence of light on the gap 325.

In contrast, according to this embodiment, the display device is fabricated as already described for Sections 7-1 to 7-4, thus providing a display device that allows the viewer to view and recognize characters, images, and other objects easily with the leakage of light reduced.

### EXAMPLES

The present invention will now be described more specifically by way of illustrative examples.

### 1. Example (P)

(1) Preparation of Adhesive

The respective components that were compounded together to have the blending ratio shown in the following Table 1 were mixed uniformly with a HOMO DISPER produced by PRIMIX Corporation to prepare an adhesive. The details of the respective components shown in the following Table 1 are:

(A)-1: glycidyl ether,

(A)-2: cresyl glycidyl ether,

(A)-3: 2-ethylhexyl glycidyl ether,

(B)-1: polypropylene glycol diglycidyl ether,

(B)-2: polybutadiene skeleton epoxy resin,

(C): triaryl sulfonium salt,

(D)-1: lauryl acrylate,

(D)-2: 1,9-nonanediol diacrylate,

(E): 1-hydroxy-cyclohexyl-phenyl-ketone,

(F): 3-ethyl-3 {[(3-ethyloxetane-3-yl)methoxy]methyl} oxetane, and

(G): liquid isoprene rubber.

TABLE 1

| | | | Blending ratio |
|---|---|---|---|
| | | | (parts by mass) |
| (A) | Monofunctional epoxy compound | (A)-1 | 5 |
| | | (A)-2 | 5 |
| | | (A)-3 | 3 |
| (B) | Polyfunctional epoxy compound | (B)-1 | 1 |
| | | (B) 2 | 9 |
| (C) | Photo cation generator | | 1 |
| (D) | Acrylic compound | (D)-1 | 15 |
| | | (D)-2 | 2 |

| | | |
|---|---|---|
| (E) | Photo-radical generator | 1 |
| (F) | Oxetane compound | 2 |
| (G) | Elastomer | 56 |

(2) Fabrication of Stacked Structure

A cover panel for smartphones and a liquid crystal panel were attached to each other to make an exemplary stacked structure. The cover panel was used as a first member and the liquid crystal panel was used as a second member. The cover panel had a longer side dimension of 156 mm, a shorter side dimension of 79 mm, and a thickness of 1 mm. The cover panel had edges with black decorative printing having a thickness of 20 μm. The liquid crystal panel had a longer side dimension of 135 mm, a shorter side dimension of 77 mm, and a thickness of 0.4 mm. A stacked panel in which the cover panel and the liquid crystal panel were arranged parallel to each other was fabricated by fixing the cover panel and the liquid crystal panel together with a cured product of the adhesive.

The stacked panel was fabricated by performing the arrangement step, irradiation step, positioning step, and curing step described above in this order.

In the arrangement step, the adhesive was applied onto the cover panel to form a coating. The adhesive was applied at a rate of 1.56 g/m² and the coating had a thickness of 150 μm.

In the irradiation step, the coating arranged on the cover panel was irradiated with an ultraviolet ray. As the ultraviolet light source, a UV-LED light source LC-L2 (manufactured by Hamamatsu Photonics K. K. and having a center wavelength of 365 nm) was used. The ultraviolet ray was radiated for 3 seconds at an illuminance of 1000 mW/cm² such that a total radiation dose would be 3000 mJ/cm². When the ultraviolet ray finished being radiated, the coating exhibited tackiness and had lost flowability.

In the positioning step, the cover panel and the liquid crystal panel were attached to each other so as to sandwich the coating that had been irradiated with an ultraviolet ray. The coating maintained its shape through the positioning step. Also, when the cover panel and the liquid crystal panel were attached to each other in the positioning step, no overflow of the adhesive or resin leakage due to insufficient curing of the adhesive occurred.

In the curing step, the cover panel and liquid crystal panel that had been attached to each other were allowed to stand still for 100 minutes to have the coating of the adhesive cured. Thus, the cover panel and the liquid crystal panel were fixed together. No parts of the coating were left uncured as a result of the curing step.

In this manner, a stacked structure, which included the cover panel as a first member, the liquid crystal panel as a second member, and a cured product of the adhesive and which had had the cover panel and the liquid crystal panel fixed together with the cured product of the adhesive, was obtained.

### 2. Example (Q)

[Preparation of First Adhesive and Second Adhesive]

The respective components that were compounded together to have the blending ratio (% by mass) shown in the following Table 2 were mixed uniformly with a DISPER to prepare a first adhesive and a second adhesive:

TABLE 2

| | | First | Second |
|---|---|---|---|
| | | adhesive | adhesive |
| Name of component | Name of substance | (dam agent) | (fill agent) |
| (B) Polyfunctional | polyethylene glycol | 1 | 1 |
| epoxy compound | diglycidyl ether | | |
| | bisphenol A diglycidyl | 29 | 26 |
| | ether | | |
| (A) Monofunctional | polyethylene glycol | 25 | 27 |
| epoxy compound | monoglycidyl ether | | |
| | phenyl glycidyl ether | 15 | 18 |
| (H) Polyfunctional | 3-ethyl-3-{[(3- | 6 | 7 |
| oxetane compound | ethyloxetane-3- | | |
| | yl)methoxy]methyl} | | |
| | oxetane | | |
| (C) Photo | ionic photoacid | 0.3 | 0.15 |
| polymerization | generating photo | | |
| initiator (photo | cation generator | | |
| cation generator) | | | |
| (G) Elastomer | butadiene rubber | 23.2 | 20.65 |
| Antioxidant | antioxidant | 0.5 | 0.2 |

The first adhesive was cured with an ultraviolet ray with a wavelength of 400 nm or less. The amount of time it took for the first adhesive to start curing since the first adhesive had just been irradiated with the ultraviolet ray (i.e., gelation time) was 5 minutes. The amount of time it took to have the first adhesive cured completely since the first adhesive had just been irradiated with the ultraviolet ray was 90 minutes.

The second adhesive was cured with an ultraviolet ray with a wavelength of 400 nm or less. The amount of time it took for the second adhesive to start curing since the second adhesive had just been irradiated with the ultraviolet ray (i.e., gelation time) was 15 minutes. The amount of time it took to have the second adhesive cured completely since the second adhesive had just been irradiated with the ultraviolet ray was 90 minutes.

[Fabrication of Stacked Structure]

A display device for smartphones was fabricated as an exemplary stacked structure. In the stacked structure, a display panel was used as its first member and a transparent plate was used as its second member. The first member was a liquid crystal panel with a longer side dimension of 130 mm, a shorter side dimension of 75 mm, and a thickness of 0.4 mm. The first member did not transmit an ultraviolet ray with a wavelength of 400 nm or less as an active energy ray. The second member was a transparent plate of polycarbonate with a longer side dimension of 140 mm, a shorter side dimension of 80 mm, and a thickness of 1 mm. The second member did not transmit an ultraviolet ray with a wavelength of 400 nm or less as an active energy ray, and had an optical transmittance of 95% in the visible radiation range. The first member and the second member were bonded and fixed together with an adhesive portion consisting of respective cured products of the first adhesive and second adhesive, thus fabricating a stacked panel in which the first member and the second member were arranged parallel to each other.

To fabricate the stacked panel, an adhesive arrangement step, an irradiation step, a positioning step, an attaching step, and a curing step were performed in this order.

In the adhesive arrangement step, the first adhesive was applied onto the upper surface of the first member to form a frame of the first adhesive thereon. The first adhesive was applied at a width of 1 mm and at an application rate of 289.7 g/m². Also, inside the first adhesive that had been applied to form a frame, the second adhesive was applied onto the upper surface of the first member to form a plurality of lines. The second adhesive was applied at a width of 1 mm and at an application rate of 144.9 g/m².

In the irradiation step, the first adhesive and the second adhesive applied onto the upper surface of the first member were irradiated with an ultraviolet ray simultaneously. As the ultraviolet light source, a UV-LED light source LC-L2 (manufactured by Hamamatsu Photonics K. K. and having a center wavelength of 365 nm) was used. The ultraviolet ray was radiated for 30 seconds at an illuminance of 100 mW/cm² such that a total radiation dose would be 3000 mJ/cm².

In the positioning step, the second member was arranged over the first member that had been subjected to the irradiation step, in order to align the second member with the first member. In this process step, the first member and the second member were arranged parallel to each other such that the lower surface of the second member would face the adhesive applied surface of the first member.

In the attaching step, after the positioning step had been performed, the first member and the second member were laid one on top of the other with an uncured adhesive interposed between them to be subjected to vacuum attaching for 60 seconds. As a result of this process step, the first adhesive was cured completely, the second adhesive was still uncured, and the first member and the second member were provisionally fixed with a cured product of the first adhesive.

In the curing step, the first member and the second member that had been attached to each other were allowed to stand still for 10 minutes to have the second adhesive cured completely.

In this manner, a stacked structure was obtained in which the first member and the second member were bonded and fixed together with an adhesive portion as respective cured products of the first and second adhesives.

The stacked panel does not have to be fabricated as described above but may also be fabricated in the following procedure.

In the same way as described above, the adhesive arrangement step, irradiation step, positioning step, attaching step, and curing step were performed in this order.

In the adhesive arrangement step, the first adhesive was applied onto the upper surface of the first member to form a frame of the first adhesive thereon. The first adhesive was applied at a width of 1 mm and at an application rate of 289.7 g/m². Also, inside the first adhesive that had been applied to form a frame, the second adhesive was applied onto the upper surface of the first member to form a plurality of lines. The second adhesive was applied at a width of 1 mm and at an application rate of 144.9 g/m². In addition, the temperature at the time of the application was set at 20° C., which is lower than room temperature (of 25° C.), and the adhesive had been cooled in advance.

In the irradiation step, the first adhesive and the second adhesive applied onto the upper surface of the first member were irradiated with an ultraviolet ray simultaneously. As the ultraviolet light source, a UV-LED light source LC-L2 (manufactured by Hamamatsu Photonics K. K. and having a center wavelength of 365 nm) was used. The ultraviolet ray was radiated for 30 seconds at an illuminance of 100 mW/cm² such that a total radiation dose would be 3000 mJ/cm².

In the positioning step, the second member was arranged over the first member that had been subjected to the irradiation step, in order to align the second member with the first member. In this process step, the first member and the second member were arranged parallel to each other such that the lower surface of the second member would face the adhesive applied surface of the first member.

In the attaching step, after the positioning step had been performed, the first member and the second member were laid one on top of the other with an uncured adhesive interposed between them to be subjected to vacuum attaching for 60 seconds. In this process step, the portion coated with the first adhesive was heated to 60° C., which is higher than room temperature. As a result of this process step, the first adhesive was cured completely, the second adhesive was still uncured, and the first member and the second member were provisionally fixed together with a cured product of the first adhesive in a shorter time due to heating.

In the curing step, the first member and the second member that had been attached to each other were allowed to stand still for 10 minutes to have the second adhesive cured completely. In addition, in this curing step, the first and second adhesives were also heated to 60° C., thus having the second adhesive cured smoothly in a shorter time.

In this manner, a stacked structure was obtained in which the first member and the second member were bonded and fixed together with an adhesive portion as respective cured products of the first and second adhesives in a shorter time by heating the adhesives to a higher temperature during curing than during application.

### 3. Example (R)

### Example R1

[Preparation of First Adhesive and Second Adhesive]

The respective components that were compounded together to have the blending ratio (% by mass) shown in the following Table 3 were mixed uniformly with a DISPER to prepare a first adhesive and a second adhesive:

TABLE 3

| | | First | Second |
|---|---|---|---|
| | | adhesive | adhesive |
| Name of component | Name of substance | (dam agent) | (fill agent) |
| (B) Polyfunctional | polyethylene glycol | 1 | 1 |
| epoxy compound | diglycidyl ether | | |
| | bisphenol A diglycidyl | 29 | 26 |
| | ether | | |
| (A) Monofunctional | polyethylene glycol | 25 | 27 |
| epoxy compound | monoglycidyl ether | | |
| | phenyl glycidyl ether | 15 | 18 |
| (H) Polyfunctional | 3-ethyl-3-{[(3- | 6 | 7 |
| oxetane compound | ethyloxetane-3- | | |
| | yl)methoxy]methyl} | | |
| | oxetane | | |
| (C) Photo | ionic photoacid | 0.3 | 0.15 |
| polymerization | generating photo | | |
| initiator (photo | cation generator | | |
| cation generator | | | |
| (G) Elastomer | butadiene rubber | 23.2 | 20.65 |
| Colorant | solvent black | 0.2 | 0 |
| Antioxidant | antioxidant | 0.5 | 0.2 |

The amount of time it took for the first adhesive to start curing since the first adhesive had just been irradiated with an ultraviolet ray (i.e., gelation time) was 5 minutes. The amount of time it took to have the first adhesive cured completely since the first adhesive had just been irradiated with the ultraviolet ray was 15 minutes. The cured product (light reducing part) of the first adhesive had an optical transmittance of 3% in the visible radiation range.

The amount of time it took for the second adhesive to start curing since the second adhesive had just been irradiated with the ultraviolet ray (i.e., gelation time) was 15 minutes. The amount of time it took to have the second adhesive cured completely since the second adhesive had just been irradiated with the ultraviolet ray was 30 minutes. The cured product (light-transmitting portion) of the second adhesive had an optical transmittance of 95% in the visible radiation range.

[Fabrication of Stacked Structure]

The liquid crystal panel had a longer side dimension of 130 mm, a shorter side dimension of 75 mm, and a thickness of 0.4 mm. The liquid crystal panel did not transmit an ultraviolet ray. The cover was a transparent plate of polycarbonate with a longer side dimension of 140 mm, a shorter side dimension of 80 mm, and a thickness of 1 mm. The cover subjected to weatherability treatment did not transmit an ultraviolet ray. The transparent portion of the cover had an optical transmittance of 95% in the visible radiation range, while the opaque portion of the cover had an optical transmittance of 0% in the visible radiation range. The liquid crystal panel and the cover were bonded and fixed together with an adhesive portion consisting of respective cured products of the first adhesive and second adhesive, thus fabricating a stacked panel in which the liquid crystal panel and the cover were arranged parallel to each other.

To fabricate the stacked panel, an adhesive arrangement step, an irradiation step, a positioning step, an attaching step, and a curing step were performed in this order.

In the adhesive arrangement step, the first adhesive was applied onto the upper surface of the liquid crystal panel to form a frame of the first adhesive thereon. The first adhesive was applied at a width of 1 mm and at an application rate of 289.7 g/m². Also, inside the first adhesive that had been applied to form a frame, the second adhesive was applied onto the upper surface of the liquid crystal panel to form a plurality of lines. The second adhesive was applied at a width of 1 mm and at an application rate of 144.9 g/m².

In the irradiation step, the first adhesive and the second adhesive applied onto the upper surface of the liquid crystal panel were irradiated with an ultraviolet ray simultaneously. As the ultraviolet light source, a UV-LED light source LC-L2 (manufactured by Hamamatsu Photonics K. K. and having a center wavelength of 365 nm) was used. The ultraviolet ray was radiated for 30 seconds at an illuminance of 100 mW/cm² such that a total radiation dose would be 3000 mJ/cm².

In the positioning step, the cover was arranged over the liquid crystal panel that had been subjected to the irradiation step, in order to align the cover with the liquid crystal panel. In this process step, the liquid crystal panel and the cover were arranged parallel to each other such that the lower surface of the cover would face the adhesive applied surface of the liquid crystal panel.

In the attaching step, after the positioning step had been performed, the liquid crystal panel and the cover were laid one on top of the other with an uncured adhesive interposed between them to be subjected to vacuum attaching for 60 seconds. As a result of this process step, the first adhesive was cured completely, the second adhesive was still uncured, and the liquid crystal panel and the cover were provisionally fixed with a cured product of the first adhesive.

In the curing step, the liquid crystal panel and the cover that had been attached to each other were allowed to stand still for 30 minutes to have the second adhesive cured completely.

In this manner, a stacked structure (see FIG. 1) was obtained in which the liquid crystal panel and the cover were bonded and fixed together with an adhesive portion as respective cured products of the first and second adhesives.

### Example R2

A stacked structure was obtained in the same way as in Example R1 except that the solvent black used as a colorant in Example R1 was replaced with titanium oxide as an alternative component.

### Comparative Example R1

A stacked structure was obtained in the same way as in Example R1 except that the solvent black used as a colorant in Example R1 was not added.

The stacked structures obtained in Examples R1 and R2 and Comparative Example R1 were evaluated in terms of the viewability of characters and images displayed on the liquid crystal panel and the degree of leakage of light from the backlight to the liquid crystal panel. The results are summarized in the following Table 4:

TABLE 4

| | | | Comparative |
|---|---|---|---|
| | Example R1 | Example R2 | Example R1 |
| First adhesive colored? | YES | YES | NO |
| | (solvent black) | (titanium oxide) | |
| Viewability | ⊚ | ◯ | ◯ |
| Leakage of light | ⊚ | ◯ | X |

In Example R1, the characters and images displayed on the liquid crystal panel were clearly readable and the viewability was excellent. Also, in Example R1, almost no light leaked from the backlight to the liquid crystal panel. Thus, Example R1 was excellent in this respect as well.

Example R2 was somewhat inferior to Example R1 in terms of viewability and leakage of light but exhibited viewability and leakage of light performance good enough to put it into practical use.

Comparative Example R1 exhibited as good viewability as Example R2 but caused leakage of light to the liquid crystal panel.

In Example R1, solvent black was used as a colorant. However, this is only an example and should not be construed as limiting. Alternatively, carbon black having the ability to shield the target from light may also be used. Optionally, titanium oxide used in Example R2, zinc oxide, and other materials with high reflectance may be added to the same amount as the colorant to cause a decrease in the optical transmittance of the first adhesive, prevent leakage of light, increase the luminance of the display screen, and thereby improve the viewability.

In the example described above, solvent black or carbon black is used to cause a decrease in optical transmittance and prevent leakage of light. However, the viewability may also be improved by causing a decrease in transmittance only with respect to light falling within the visible radiation range. In that case, an equivalent amount of copper-porphyrin complex or Co phthalocyanine may be added to the first adhesive.

### 4. Example (S)

[1. Preparation of Composition (X)]

The respective components that were compounded together to have the mass ratio shown in the following Table 5 were mixed uniformly with a DISPER produced by PRIMIX Corporation to prepare a Composition (X). The details of the respective components shown in the following Table 5 are:

(A2-1): glycidyl ether,

(A2-2): cresyl glycidyl ether,

(B1): polypropylene glycol diglycidyl ether,

(B2): polybutadiene skeleton epoxy resin,

(B3): hydrogenated bisphenol A type epoxy resin,

(C-1): triaryl sulfonium salt,

(C-2): triaryl sulfonium borate salt,

(D-1): lauryl acrylate,

(D-2): 1,9-nonanediol diacrylate,

(E): 1-hydroxy-cyclohexyl-phenyl-ketone,

(F): 2-ethylhexyl oxetane,

(G1): liquid isoprene rubber (non-hydrogenated),

(G2): hydrogenated polybutadiene rubber, and

(H-1): 3-ethyl-3{[(3-ethyloxetane-3-yl)methoxy]methyl} oxetane.

[2. Evaluation]

<Time Delay>

The time delay was measured using, as an index to the slow curing properties, a variation in viscosity after the adhesive had been irradiated with an ultraviolet ray in an atmosphere at room temperature of 25° C. Specifically, the viscosities of the respective compositions representing examples and comparative examples shown in Table 1 were measured with a UV radiating rheometer MCR-100 (manufactured by Anton Paar Japan) before the compositions were irradiated with an ultraviolet ray and variations in their viscosity were also measured after the compositions were irradiated with an ultraviolet ray. As the ultraviolet light source, a UV-LED light source LC-L2 (manufactured by Hamamatsu Photonics K. K. and having a center wavelength of 365 nm) was used. The ultraviolet ray was radiated for 5 seconds at an illuminance of 100 mW/cm² such that a total radiation dose would be 500 mJ/cm².

The time delay was defined to be the amount of time it took for the viscosity of a liquid photo cation polymerized composition to reach 50000 Pa·s since the photo cation polymerized composition had just been irradiated with an ultraviolet ray. This definition was adopted because the viscosity at which the flowability is lost almost entirely to disable attaching is about 50000 Pa s. If this time delay is equal to or less than 15 seconds, there is little time allowed for attaching. Nevertheless, if this time delay is equal to or greater than 60 minutes, there is a good chance that the members are displaced from each other.

Also, if the composition includes a photo-radical generator and an acrylic compound, the composition will turn primarily cured and come to have tackiness when irradiated with light. After that, the photo cation polymerized composition component will be cured to turn secondarily cured so as to have a viscosity of 50000 Pa·s. In this case, the primary curing occurs only while the composition is being irradiated with light. The time delay was regarded as an amount of time it took for the composition to come to have certain elasticity, tackiness, and a viscosity of 50000 Pa·s. When the composition contains a photo-radical generator, the time delay could be longer than 60 minutes. However, since the composition is primarily cured, the members may be attached to each other in that state and the assembly may also be transported while being kept in shape due to the tackiness, thus ensuring a long pot life. As a result, a so-called “curing time” for which the members are held with a jig, for example, becomes relatively short.

<Discoloration>

Using two glass panes and spacers, the Composition (X) was sandwiched between the glass panes such that the resin portion would have a thickness of 1 mm. The Composition (X) was irradiated with an active energy ray at a dose of 3000 mJ/cm² and then cured at room temperature for one day to obtain a test piece.

The test piece obtained by this method was loaded into a constant temperature chamber at 95° C. When a predetermined amount of time passed, a determination was made whether or not the test piece discolored.

The discoloration test was carried out in this procedure to rate the test pieces as one of the following grades:

A: Not discolored;

B: Discolored lightly but too much to use it in practice;

C: Discolored sensibly; and

D: Discolored significantly

[3. Results]

In Examples S1-S4 containing no photo-radical generators or acrylic compounds, the composition irradiated with light was in liquid form, and caused some time delay before the composition started curing.

Example S1, containing no Component (A), included (B) a polyfunctional epoxy compound with an ether skeleton and (F) a monofunctional oxetane compound, thus requiring two hours or more for starting curing. Example S2 containing (B) a polyfunctional epoxy compound with no ether skeleton required two hours for starting curing.

Next, the content of (F) the monofunctional oxetane compound was adjusted to increase the epoxy content. As a result, the composition started curing within 60 minutes as in Examples S3 and S4. In addition, the composition containing an ether skeleton in a small amount could have an extended time before the start of curing.

On the other hand, Example S5, containing (E) a photo-radical generator and (D) an acrylic compound, turned tacky while being primarily cured after having been irradiated with light and maintained tackiness for 60 minutes before curing.

Examples S6 and S7 contained hydrogenated epoxy and elastomer, and therefore, could start curing within 60 minutes with their discoloration reduced.

TABLE 5

| | | | | | | | | | | | Cmp. | Cmp. |
|---|---|---|---|---|---|---|---|---|---|---|---|---|
| Component | | | | Ex. S1 | Ex. S2 | Ex. S3 | Ex. S4 | Ex. S5 | Ex. S6 | Ex. S7 | Ex. S1 | Ex. S2 |
| A | Monofunctional epoxy | A2-1 | no polyether skeleton | — | — | — | — | — | 5 | — | 45 | 10 |
| | compound | A2-2 | no polyether skeleton | — | — | — | — | — | — | — | — | 5 |
| B | Polyfunctional epoxy | B1 | with polyether skeleton | 45 | — | — | 5 | 1 | 1 | 1 | 45 | — |
| | compound | B2 | no polyether skeleton | — | 45 | 70 | 65 | 20 | — | — | — | 20 |
| | | B3 | hydrogenated | — | — | — | — | — | 20 | 20 | — | — |
| C | Photo cation generator | C-1 | | — | — | — | — | 1 | 1 | 1 | — | 1 |
| | | C-2 | | 2 | 2 | 2 | 2 | — | — | — | 2 | — |
| D | Acrylic compound | D-1 | | — | — | — | — | 20 | 20 | 20 | — | 20 |
| | | D-2 | | — | — | — | — | 7 | 7 | 7 | — | 7 |
| E | Photo-radical generator | | | — | — | — | — | 1 | 1 | 1 | — | 1 |
| F | Monofunctional oxetane compound | | | 45 | 45 | 20 | 20 | 15 | 5 | 10 | — | — |
| G | Elastomer | G1 | non-hydrogenated | — | — | — | — | 30 | — | — | — | 30 |
| | | G2 | hydrogenated | — | — | — | — | — | 30 | 30 | — | — |
| H | Polyfunctional oxetane | H-1 | | 10 | 10 | 10 | 10 | 8 | 8 | 8 | 10 | — |
| | compound | | | | | | | | | | | |

| | | | | | | | | | | |
|---|---|---|---|---|---|---|---|---|---|---|
| Evaluation | state after irradiation | liquid | liquid | liquid | liquid | tacky | tacky | tacky | liquid | tacky |
| | with light | | | | | | | | | |
| | time delay | ≥2 hrs | 2 hrs | 30 min | 60 min | 60 min | 45 min | 60 min | 60 min | ≥2 hrs |
| | discolored or not | B | B | B | B | B | A | A | B | B |

### 5. Example (T)

[1. Preparation of Composition (X)]

The respective components that were compounded together to have the mass ratio shown in the following Tables 6 and 7 were mixed uniformly with a DISPER produced by PRIMIX Corporation to prepare a Composition (X). The details of the respective components shown in the following Tables 6 and 7 are:

(A): lauryl alcohol glycidyl ether,

(B-1): polybutadiene type epoxy resin,

(B-2): polypropylene glycol diglycidyl ether,

(B-3): hydrogenated bisphenol A type epoxy resin,

(C-1): triaryl sulfonium, special phosphorus-based anionic salt,

(C-2): triaryl sulfonium borate salt,

(D): lauryl acrylate,

(E): 1-hydroxy-cyclohexyl-phenyl-ketone,

(F): 2-ethylhexyl oxetane,

(G): hydrogenated polybutadiene rubber,

(H): 3-ethyl-3-{[(3-ethyloxetane-3-yl)methoxy]methyl} oxetane,

(i1): vinyltriethoxysilane (see Structural Formula (i-1)),

(i2): 2-(3,4-epoxycyclohexyl) ethyl trimethoxysilane (see Structural Formula (i-2)),

(i3): 3-glycidoxypropyl trimethoxysilane (see Structural Formula (i-3)), and

(i4): 3-methacryloxypropyl trimethoxysilane (see Structural Formula (i-4)).

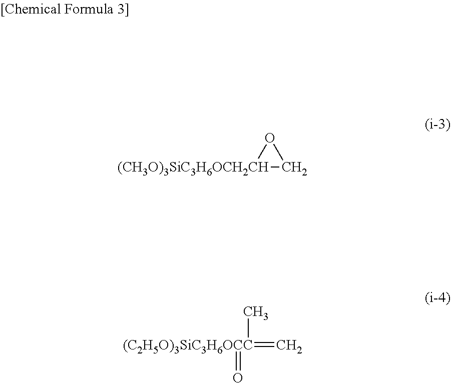

[2. Evaluation]

<Variation in Resistance Value>

An interdigital electrode of indium tin oxide (ITO) was formed on the surface of a substrate and photocurable resin compositions representing examples and comparative examples were applied onto the surface of the substrate so as to cover the interdigital electrode. Next, the photocurable resin compositions were irradiated with, and cured by, an ultraviolet ray to make test pieces. As the ultraviolet light source, a UV-LED light source LC-L2 (manufactured by Hamamatsu Photonics K. K. and having a center wavelength of 365 nm) was used. The ultraviolet ray was radiated for 5 seconds at an illuminance of 100 mW/cm² such that a total radiation dose would be 500 mJ/cm². Thereafter, the test pieces were left in a high-temperature, high-humidity environment with a temperature of 60° C. and a humidity of 80% for 300 hours with a DC voltage of 10 V applied thereto.

Then, the variation in the resistance value of the interdigital electrode before and after having been left in the high-temperature, high-humidity environment was measured. When the resistance value was measured, a DC voltage of 10 V was applied thereto, and the value of a current flowing at that time was measured. A test piece, of which the resistance value after having been left in the high-temperature, high-humidity environment varied by one digit or more from its resistance value before being left in the environment (initial value), is indicated by the cross (X), while a test piece, of which the resistance value varied by less than one digit, is indicated by the open circle (O).

Note that the interdigital electrode of the test pieces was provided with no protective coating. In an actual product, the surface of an electrode material may be coated with an anticorrosion insulating film of a dielectric such as Si₂O₄ in order to increase the anticorrosion properties. This significantly reduces the risk of the electrode corroding.

<Change in Appearance>

The appearance of the cured products of the photocurable resin compositions before and after having been left in the high-temperature, high-humidity environment was observed with naked eyes to confirm if any change occurred. Based on the results of the observation, the test pieces were rated as one of the three grades: no change observed, colored, or disappeared.

[3. Results]

As shown in the following Table 6, in Comparative Example T1 with no coupling agent, the electrode disappeared due to a strong acid species generated by the photo cation generator C-1 and the resistance value varied significantly. In Comparative Examples T2 and T3 including a coupling agent with a long organic functional group, the electrode also disappeared and the resistance value also varied as significantly as in Comparative Example T1. Meanwhile, in Examples T1 and T2 including a coupling agent with an organic functional group having a small number of carbons and a short molecular chain, the appearance of the electrode did not change and no variation in resistance was detected.

Next, in Examples T3 and T4 in which the content of the coupling agent was changed, the electrode was certainly colored but when the content of the coupling agent was 0.017%, the variation in resistance value was insignificant, which proved that some effect was achieved. However, when the content of the coupling agent was 0.003% or less, the resistance value varied significantly, indicating that such a composition would be unusable in practice.

Next, as shown in the following Table 7, when the photo cation generator was changed into a so-called “borate-based” one, the electrode did not disappear but was colored in Comparative Example T4 including no coupling agents. This is presumably because acidic ion molecules of the borate-based photo cation generator are larger than the other types and cannot move easily within the cured product, thus decreasing the contact of the molecules with the electrode on the surface of the base member and making the molecules less easily oxidized. Without the coupling agent, however, the resistance value varied too significantly to use the composition in practice. Also, in Comparative Examples 5 and 6 including a coupling agent with a long organic functional group, the electrode did not disappear, either, and was colored as well. Nevertheless, the resistance value varied too significantly to use the composition in practice. In contrast, in Examples T5 and T6 including a coupling agent with an organic functional group having a small number of carbons and a short molecular chain, the appearance of the electrode did not change and no variation in resistance was detected, which was a very good result. Taking the results of Comparative Examples T5 and T6 into consideration in combination with these results of Examples T5 and T6, it can be seen that using the borate-based photo cation generator and the coupling agent with a short molecular chain in combination is very effectively and reliably applicable to preventing the corrosion of the electrode.

In the example described above, a composition including an epoxy compound and a photo cation generator has been described as an example. This is because when a composition includes a photo-radical generator (radical polymerization initiator) and an acrylic compound, these components do not generate a strong acid that causes the electrode to be corroded. That is to say, the effect of the coupling agent significantly reducing the harmful influence of a strong acid generated from the photo cation generator is well evidenced.

In Example T7 including a photo cation generator, an epoxy compound, a photo-radical generator, an acrylic compound, and a coupling agent, no corrosion of the electrode was observed and the variation in resistance value was much less significant.

Note that the substance described for this example is only an example and should not be construed as limiting. This example teaches that the coupling agent is able to effectively protect a corrosive substance such as an electrode from a strong acid generated from a photo cation generator. In addition, using a borate-based material with little corrosiveness (i.e., a borate salt type photo cation generator) and the coupling agent in combination is able to reduce the risk of electrode corrosion significantly. In particular, this allows for increasing the number of applicable options of a material including a photo cation generator which may be either attached or reworked even after having been irradiated with light and which starts curing in a predetermined amount of time.

TABLE 6

| | | | Ex. T1 | Ex. T2 | Cmp. Ex. T1 | Cmp. Ex. T2 | Cmp. Ex. T3 | Ex. T3 | Ex. T4 |
|---|---|---|---|---|---|---|---|---|---|
| A | Monofunctional epoxy compound | | 8.85 | 8.85 | 8.85 | 8.85 | 8.85 | 8.85 | 8.85 |
| B | Polyfunctional epoxy compound | B-1 | 0.24 | 0.24 | 0.24 | 0.24 | 0.24 | 0.24 | 0.24 |
| | | B-2 | 5.89 | 5.89 | 5.89 | 5.89 | 5.89 | 5.89 | 5.89 |
| C | Photo cation generator | C-1 | 0.15 | 0.15 | 0.15 | 0.15 | 0.15 | 0.15 | 0.15 |
| | | C-2 | — | — | — | — | — | — | — |
| G | Elastomer | | 12.22 | 12.22 | 12.22 | 12.22 | 12.22 | 12.22 | 12.22 |
| H | Polyfunctional oxetane compound | | 2.74 | 2.74 | 2.74 | 2.74 | 2.74 | 2.74 | 2.74 |
| I | Coupling agent | i1 | 0.30 | — | — | — | — | 0.005 | 0.002 |
| | | i2 | — | 0.30 | — | — | — | — | — |
| | | i3 | — | — | — | 0.30 | — | — | — |
| | | i4 | — | — | — | — | 0.30 | — | — |

| | | | | | | | |
|---|---|---|---|---|---|---|---|
| Content of coupling agent | 0.99% | 0.99% | 0.00% | 0.99% | 0.99% | 0.017% | 0.007% |

| | | | | | | | |
|---|---|---|---|---|---|---|---|
| Total | 30.40 | 30.40 | 30.10 | 30.40 | 30.40 | 30.11 | 30.10 |
| Variation in resistance | ◯ | ◯ | X | X | X | ◯ | Δ |
| Change in appearance | unchanged | unchanged | disappeared | disappeared | disappeared | colored | colored |

TABLE 7

| | | | Ex. T5 | Ex. T6 | Cmp. Ex. T4 | Cmp. Ex. T5 | Cmp. Ex. T6 | Ex. T7 |
|---|---|---|---|---|---|---|---|---|
| A | Monofunctional epoxy compound | | 8.85 | 8.85 | 8.85 | 8.85 | 8.85 | 20 |
| B | Polyfunctional epoxy compound | B-1 | 0.24 | 0.24 | 0.24 | 0.24 | 0.24 | 5 |
| | | B-2 | 5.89 | 5.89 | 5.89 | 5.89 | 5.89 | |
| C | Photo cation generator | C-1 | — | — | — | — | — | 1 |
| | | C-2 | 0.15 | 0.15 | 0.15 | 0.15 | 0.15 | — |
| D | Acrylic compound | | — | — | — | — | — | 15 |
| E | Photo-radical generator | | — | — | — | — | — | 0.5 |
| F | Monofunctional oxetane compound | | — | — | — | — | — | 35 |
| G | Elastomer | | 12.22 | 12.22 | 12.22 | 12.22 | 12.22 | 30 |
| H | Polyfunctional oxetane compound | | 2.74 | 2.74 | 2.74 | 2.74 | 2.74 | 8 |
| I | Coupling agent | i1 | 0.30 | — | — | — | — | 0.02 |
| | | i2 | — | 0.30 | — | — | — | — |
| | | i3 | — | — | — | 0.30 | — | — |
| | | i4 | — | — | — | — | 0.30 | — |

| | | | | | | |
|---|---|---|---|---|---|---|
| Content of coupling agent | 0.99% | 0.99% | 0.00% | 0.99% | 0.99% | 0.0149% |

| | | | | | | |
|---|---|---|---|---|---|---|
| Total | 30.40 | 30.40 | 30.10 | 30.40 | 30.40 | 134.02 |
| Variation in resistance | ◯ | ◯ | X | X | X | ◯ |
| Change in appearance | unchanged | unchanged | colored | colored | colored | unchanged |

### 6. Example (U)

[1. Preparation of Composition (X)]

The respective components that were compounded together to have the mass ratio shown in the following Table 8 were mixed uniformly with a DISPER produced by PRIMIX Corporation to prepare a Composition (X). The details of the respective components shown in the following Table 8 are:

(A2-1): alkyl glycidyl ether (of which an alkyl group has a carbon number of 10-15; with no double bonds),

(A2-2): cresyl glycidyl ether (with double bonds),

(B1): polypropylene glycol diglycidyl ether (non-hydrogenated),

(B2): bisphenol A type epoxy resin (non-hydrogenated),

(B3): hydrogenated bisphenol A type epoxy resin (hydrogenated),

(C): triaryl sulfonium salt,

(D-1): lauryl acrylate,

(D-2): 1,9-nonanediol diacrylate,

(E): 1-hydroxy-cyclohexyl-phenyl-ketone,

(F): 2-ethylhexyl oxetane,

(G1): polybutadiene rubber (non-hydrogenated),

(G2): hydrogenated polybutadiene rubber (hydrogenated),

(H-1): 3-ethyl-3{[(3-ethyloxetane-3-yl)methoxy]methyl} oxetane (with no double bonds), and

(H-2): xylylene bisoxetane (with double bonds)

[2. Evaluation]

<Discoloration>

Using two glass panes and spacers, the Composition (X) was sandwiched between the glass panes such that the resin portion would have a thickness of 1 mm. The Composition (X) was irradiated with an active energy ray at a dose of 3000 mJ/cm² and then cured at room temperature for one day to obtain a test piece.

The test piece obtained by this method was loaded into a constant temperature chamber at 95° C. When a predetermined amount of time passed, a determination was made whether or not the test piece discolored.

The degree of discoloration was evaluated by yellowness index (Y1). The measurement was carried out with CM-5 manufactured by Konica Minolta, Inc.

The discoloration test was carried out in this procedure to rate the test pieces as one of the following four grades:

A: Not discolored;

B: Discolored lightly but too much to use it in practice;

C: Discolored sensibly; or

D: Discolored significantly

[3. Results]

Examples U1-U5 including a polyfunctional epoxy compound or elastomer treated by hydrogenation reaction showed a decreased degree of discoloration. In particular, a composition, of which the polyfunctional epoxy compound and elastomer were both treated by hydrogenation reaction, showed further decreased discoloration. Furthermore, when a monofunctional epoxy compound with no double bonds was used without a monofunctional epoxy compound with double bonds, the degree of discoloration further decreased.

TABLE 8

| | | | | | | | | | Cmp. | Cmp. | Cmp. | Cmp. |
|---|---|---|---|---|---|---|---|---|---|---|---|---|
| Component | | | | Ex. U1 | Ex. U2 | Ex. U3 | Ex. U4 | Ex. U5 | Ex. U1 | Ex. U2 | Ex. U3 | Ex. U4 |
| A | Monofunctional epoxy | A2-1 | no double bonds | 10 | 10 | 10 | 20 | 20 | 10 | 20 | 10 | 20 |
| | compound | A2-2 | with double bonds | 10 | 10 | 10 | — | — | 10 | — | 10 | — |
| B | Polyfunctional epoxy | B1 | non-hydrogenated | 5 | 5 | 5 | 5 | 5 | 5 | 5 | 5 | 5 |
| | compound | B2 | non-hydrogenated | — | 20 | — | — | — | 20 | 20 | 20 | 20 |
| | | B3 | hydrogenated | 20 | — | 20 | 20 | 20 | — | — | — | — |
| C | Photo cation generator | | | 1 | 1 | 1 | 1 | 1 | 1 | 1 | 1 | 1 |
| D | Acrylic compound | D-1 | | — | — | — | — | 10 | — | — | — | — |
| | | D-2 | | — | — | — | — | 5 | — | — | — | — |
| E | Photo-radical generator | | | — | — | — | — | 1 | — | — | — | — |
| F | Monofunctional oxetane | | | 5 | 5 | 5 | 5 | 5 | 5 | 5 | 5 | 5 |
| | compound | | | | | | | | | | | |
| G | Elastomer | G1 | non-hydrogenated | 30 | — | — | — | — | 30 | 30 | 30 | 30 |
| | | G2 | hydrogenated | — | 30 | 30 | 30 | 30 | — | — | — | — |
| H | Polyfunctional oxetane | H-1 | no double bonds | — | — | — | 8 | 8 | — | — | 8 | 8 |
| | compound | H-2 | with double bonds | 8 | 8 | 8 | — | — | 8 | 8 | — | — |

| | | | | | | | | | | |
|---|---|---|---|---|---|---|---|---|---|---|
| Evaluation | discolored? | C | C | B | A | A | D | C | C | B |

As can be seen from the foregoing description, an adhesive according to a first aspect contains: a monofunctional epoxy compound having one epoxy group per molecule as Component (A); a polyfunctional epoxy compound having two or more epoxy groups per molecule as Component (B); a photo cation generator as Component (C); an acrylic compound as Component (D); a photo-radical generator as Component (E); and at least one compound selected from the group consisting of a monofunctional oxetane compound as Component (F) and a polyfunctional oxetane compound as Component (H).

An adhesive with this composition is in liquid form before being irradiated with an active energy ray and will turn, when applied as an adhesive coating onto a given member, into a shape conforming to that of the given member. This reduces the chances of air bubbles entering the gap between the given member and the coating. In addition, while being irradiated with an active energy ray, the adhesive coating has a storage modulus higher than a loss modulus and comes to have decreased flowability. This allows the adhesive to maintain the coating shape and reduces the deformation of the coating when the members are attached to each other. This reduces the overflow of the adhesive. Besides, the adhesive coating's ability to turn into any arbitrary shape makes the adhesive applicable to attaching even members with a complex shape. Furthermore, the adhesive starts curing when a predetermined amount of time passes since the adhesive was irradiated with an active energy ray and then is completely cured. Thus, after having been attached to each other with the adhesive coating, a plurality of members will be fixed together. This allows the plurality of members to be fixed together without being affected by the optical transmittance of the members, and reduces the chances of causing resin leakage due to insufficient curing of the adhesive. This reduces the chances of other members being contaminated with the resin leakage. Moreover, once irradiated with the active energy ray, the adhesive is able to go through the primary curing, secondary curing, and complete curing. Thus, the adhesive to be cured does not have to go through a plurality of treatments using either ultraviolet radiation and heat or ultraviolet radiation and moisture in combination.

In an adhesive according to a second aspect, which may be implemented in conjunction with the first aspect, the Component (A) includes at least one compound selected from the group consisting of: polyethylene glycol monoglycidyl ether; polypropylene glycol monoglycidyl ether; and polytetramethylene glycol monoglycidyl ether, and the Component (B) includes at least one compound selected from the group consisting of: polyethylene glycol diglycidyl ether; polypropylene glycol diglycidyl ether; and polytetramethylene glycol diglycidyl ether.

In this case, both of these Components (A) and (B) have a polyether skeleton. This reduces the chances of the polyether skeleton portion being bred out after the adhesive has been cured.

In an adhesive according to a third aspect, which may be implemented in conjunction with the first or second aspect, the ratio by mass of the total content of the Components (A) and (B) to the content of the Component (D) falls within a range from 5:95 to 90:10.

This allows the adhesive coating to turn, when irradiated with an active energy ray, primarily cured so as to have tackiness with no adhesiveness while maintaining the coating shape. This reduces the chances of the coating on a member being deformed while the member is being transported and also reduces the overflow of the adhesive when a plurality of members are attached to each other with the coating interposed between them. In addition, this also allows a plurality of members with different radii of curvature to be attached to each other with a consistent film thickness.

A stacked structure (1) according to a fourth aspect includes: a cured product (20) of the adhesive according to any one of the first to third aspects; a first member (10); and a second member (11). The first member (10) and the second member (11) are fixed together with the cured product (20).

This reduces the chances of the stacked structure (1) going defective due to intrusion of air bubbles or insufficient curing of the adhesive. In addition, this also allows even the first member (10) and second member (11) with low optical transmittance to be bonded sufficiently firmly together.

A method for fabricating a stacked structure (1) according to a fifth aspect includes: an arrangement step of arranging an uncured coating (12) of the adhesive according to any one of the first to third aspects on at least one member selected from the group consisting of a first member (10) or a second member (11); an irradiation step of irradiating the uncured coating (12) with an active energy ray after the arrangement step has been performed; a positioning step of positioning the first member (10) and the second member (11) with the uncured coating (12) interposed after the irradiation step has been performed; and a curing step of fixing the first member (10) and the second member (11) together by completely curing the uncured coating (12) after the positioning step has been performed.

This allows the coating (12) of the adhesive to maintain its shape easily and reduces the chances of the intrusion of air bubbles and insufficient curing of the adhesive. In addition, this also allows even the first member (10) and second member (11) with low optical transmittance to be bonded sufficiently firmly together.

In a method for fabricating a stacked structure (1) according to a sixth aspect, which may be implemented in conjunction with the fifth aspect, irradiating the uncured coating with the active energy ray causes a radical polymerization reaction between the Components (D) and (E) in the irradiation step to turn the uncured coating (12) primarily cured; keeps the cured coating (12) primarily cured in the positioning step; and causes a cationic polymerization reaction between the Components (A), (B), (C), and (F) in the curing step to have the uncured coating (12) completely cured.

This reduces the overflow of the adhesive when a plurality of members are attached to each other, and makes the adhesive applicable to bonding members with low optical transmittance. In addition, this also allows the coating (12) of the adhesive to turn into any arbitrary shape, thus making the adhesive applicable to bonding even members with a complex shape.

### REFERENCE SIGNS LIST

1 Stacked Structure
10 First Member
11 Second Member
12 Coating
20 Cured Product

1. An adhesive comprising:
a monofunctional epoxy compound having one epoxy group per molecule as Component (A);
a polyfunctional epoxy compound having two or more epoxy groups per molecule as Component (B);
a photo cation generator as Component (C);
an acrylic compound as Component (D);
a photo-radical generator as Component (E); and
at least one compound selected from the group consisting of a monofunctional oxetane compound as Component (F) and a polyfunctional oxetane compound as Component (H).

2. The adhesive of claim 1, wherein
the Component (A) includes at least one compound selected from the group consisting of: polyethylene glycol monoglycidyl ether; polypropylene glycol monoglycidyl ether; and polytetramethylene glycol monoglycidyl ether, and
the Component (B) includes at least one compound selected from the group consisting of: polyethylene glycol diglycidyl ether; polypropylene glycol diglycidyl ether; and polytetramethylene glycol diglycidyl ether.

3. The adhesive of claim 1, wherein
a ratio by mass of total content of the Components (A) and (B) to content of the Component (D) falls within a range from 5:95 to 90:10.

4. A stacked structure comprising:
a cured product of the adhesive of claim 1;
a first member; and
a second member,
the first member and the second member being fixed together with the cured product.

5. A method for fabricating a stacked structure, the method comprising:
an arrangement step of arranging an uncured coating of the adhesive of claim 1 on at least one member selected from the group consisting of a first member and a second member;
an irradiation step of irradiating the uncured coating with an active energy ray after the arrangement step has been performed;
a positioning step of positioning the first member and the second member with the uncured coating interposed after the irradiation step has been performed; and
a curing step of fixing the first member and the second member together by completely curing the uncured coating after the positioning step has been performed.

6. The method of claim 5, wherein
irradiating the uncured coating with the active energy ray:
causes a radical polymerization reaction between the Components (D) and (E) in the irradiation step to turn the uncured coating primarily cured;
keeps the uncured coating primarily cured in the positioning step; and
causes a cationic polymerization reaction between the Components (A), (B), (C), and (F) or (H) in the curing step to have the uncured coating completely cured.

7-18. (canceled)

19. A photocurable resin composition having a property of being cured when exposed to light, the photocurable resin composition comprising:
(B) 10 parts by mass to 95 parts by mass of a polyfunctional epoxy compound; and
(F) 5 parts by mass to 90 parts by mass of a monofunctional oxetane compound.

20. The photocurable resin composition of claim 19, further comprising (H) a polyfunctional oxetane compound, wherein
total content of (B) the polyfunctional epoxy compound and (H) the polyfunctional oxetane compound falls within a range from 10 parts by mass to 95 parts by mass.

21. The photocurable resin composition of claim 20, wherein
content of (H) the polyfunctional oxetane compound falls within a range from 1 part by mass to 30 parts by mass.

22. The photocurable resin composition of claim 19, wherein
(B) the polyfunctional epoxy compound contains a bifunctional epoxy resin.

23. The photocurable resin composition of claim 19, further comprising (D) an acrylic compound.

24. The photocurable resin composition of claim 23, further comprising (A) a monofunctional epoxy compound, wherein
a ratio by mass of total content of (A) the monofunctional epoxy compound and (B) the polyfunctional epoxy compound to content of (D) the acrylic compound falls within a range from 5:95 to 90:10.

25. A photocurable resin composition having a property of being cured when exposed to light, the photocurable resin composition comprising:
either (A) a monofunctional epoxy compound or (F) a monofunctional oxetane compound, or both of these compounds (A) and (F);
(B) a polyfunctional epoxy compound;
(C) a photo cation generator; and
(I) a coupling agent,
(I) the coupling agent containing (i) a silane coupling agent having an organic functional group, of which a linear carbon chain has a carbon number of two or less.

26. The photocurable resin composition of claim 25, wherein
(i) the silane coupling agent having the organic functional group, of which the linear carbon chain has a carbon number of two or less, contains at least one silane coupling agent selected from the group consisting of two silane coupling agents expressed by the following chemical structural formulae (i-1) and (i-2):

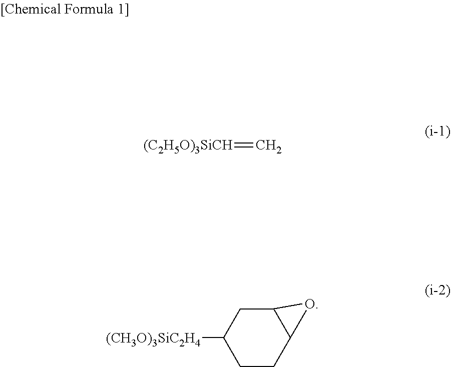

27. The photocurable resin composition of claim 25, wherein
content of (i) the silane coupling agent, having the organic functional group, of which the linear carbon chain has a carbon number of two or less, is equal to or greater than 0.01 parts by mass relative to total of 100 parts by mass.

28. The photocurable resin composition of claim 25, wherein
(C) the photo cation generator contains a photo cation generator of a borate salt type.

29. A photocurable resin composition having a property of being cured when exposed to light, the photocurable resin composition comprising:
either (A) a monofunctional epoxy compound or (F) a monofunctional oxetane compound, or both of these compounds (A) and (F);
(B) a polyfunctional epoxy compound;
(C) a photo cation generator; and
(G) an elastomer,
(B) the polyfunctional epoxy compound containing (B3) a polyfunctional epoxy compound treated by hydrogenation reaction.

30. A photocurable resin composition having a property of being cured when exposed to light, the photocurable resin composition comprising:
either (A) a monofunctional epoxy compound or (F) a monofunctional oxetane compound, or both of these compounds (A) and (F);
(B) a polyfunctional epoxy compound;
(C) a photo cation generator; and
(G) an elastomer,
(G) the elastomer containing (G2) an elastomer treated by hydrogenation reaction.

31. The photocurable resin composition of claim 30, wherein
(B) the polyfunctional epoxy compound contains (B3) a polyfunctional epoxy compound treated by hydrogenation reaction.

32. The photocurable resin composition of claim 29, further comprising (H) a polyfunctional oxetane compound.

33. The photocurable resin composition of claim 29, wherein
at least one compound selected from the group consisting of (A) the monofunctional epoxy compound, (F) the monofunctional oxetane compound, and (H) the polyfunctional oxetane compound further contains a compound treated by hydrogenation reaction.

34. The photocurable resin composition of claim 29, further comprising (D) an acrylic compound.

35. The photocurable resin composition of claim 34, wherein
a ratio by mass of total content of (A) the monofunctional epoxy compound and (B) the polyfunctional epoxy compound to content of (D) the acrylic compound falls within a range from 5:95 to 90:10.

36. The photocurable resin composition claim 29, wherein
content of a compound not treated by the hydrogenation reaction and having no double bonds is equal to or greater than 50% by mass and content of a compound treated by the hydrogenation reaction is equal to or greater than 20% by mass.

37. An adhesive comprising the photocurable resin composition of claim 19.
